(19) United States
(12) Patent Application Publication
(10) Pub. No.: US 2025/0218031 A1
(43) Pub. Date: Jul. 3, 2025

(54) INFORMATION PROCESSING APPARATUS, INFORMATION PROCESSING METHOD, AND NON-TRANSITORY COMPUTER READABLE MEDIUM

(71) Applicant: NEC Corporation, Minato-ku, Tokyo (JP)

(72) Inventor: Yuka Ogino, Tokyo (JP)

(73) Assignee: NEC Corporation, Minato-ku, Tokyo (JP)

(21) Appl. No.: 18/850,131

(22) PCT Filed: Jun. 21, 2023
(86) PCT No.: PCT/JP2023/023008

§ 371 Date: Sep. 24, 2024

(30) Foreign Application Priority Data
Jun. 28, 2022 (JP) 2022-103353

(51) Int. Cl. G06T 7/73; G06F 3/01; G06V 10/44; G06V 10/74

(52) U.S. Cl. CPC G06T 7/73; G06F 3/013; G06V 10/44; G06V 10/761; G06T 2207/20081; G06T 2207/30196

(57) ABSTRACT

An information processing apparatus (100) includes a target image acquisition unit (101) and a position estimation unit (110). The target image acquisition unit (101) acquires an estimation target image including an image of a target part in an estimation target. The position estimation unit (110) extracts a target part feature related to a portion associated with the target part from a feature of the estimation target image, based on a learning result acquired by performing learning by using a reference image including an image of the target part and a target image including an image of the target part, and estimates a position of the target part, based on the target part feature.

### TECHNICAL FIELD

This disclosure relates to an information processing apparatus, an information processing method, an information processing system, and a storage medium.

### BACKGROUND ART

Various techniques for acquiring information about an eye of a person from an image being a target are proposed.

For example, Patent Document 1 discloses an object tracking method for detecting a specific object from a captured image acquired in time series by using a tracking technique by template matching, and tracking a position of the specific object.

For example, Patent Document 2 discloses a technique for deciding whether a second image in which at least one of a right eye and a left eye of a user is captured is the left eye or the right eye of the user, based on a first image including a whole body of the user.

### RELATED DOCUMENT

### Patent Document

Patent Document 1: Japanese Patent Application Publication No. 2014-063280
Patent Document 2: International Patent Publication No. WO2020/079741

### DISCLOSURE OF THE INVENTION

### Technical Problem

This disclosure has an object to improve the techniques described in the related documents described above.

### Solution to Problem

One aspect of this disclosure provides an information processing apparatus including:
a target image acquisition unit that acquires an estimation target image including an image of a target part in an estimation target; and
a position estimation unit that extracts a target part feature related to a portion associated with the target part from a feature of the estimation target image, based on a learning result acquired by performing learning by using a reference image including an image of a target part and a target image including an image of the target part, and estimates a position of the target part, based on the target part feature.

One aspect of this disclosure provides an information processing system including:
the information processing apparatus described above; and
a capturing apparatus for capturing the estimation target.

One aspect of this disclosure provides an information processing method including,
by one or more computers:
acquiring an estimation target image including an image of a target part in an estimation target; and
extracting a target part feature related to a portion associated with the target part from a feature of the estimation target image, based on a learning result acquired by performing learning by using a reference image including an image of a target part and a target image including an image of the target part, and estimating a position of the target part, based on the target part feature.

One aspect of this disclosure provides a storage medium storing a program for causing one or more computers to execute:
acquiring an estimation target image including an image of a target part in an estimation target; and
extracting a target part feature related to a portion associated with the target part from a feature of the estimation target image, based on a learning result acquired by performing learning by using a reference image including an image of a target part and a target image including an image of the target part, and estimating a position of the target part, based on the target part feature.

### BRIEF DESCRIPTION OF THE DRAWINGS

FIG. 1 is a diagram illustrating an overview of an information processing apparatus according to an example embodiment 1.

FIG. 2 is a diagram illustrating an overview of information processing according to the example embodiment 1.

FIG. 3 is a diagram illustrating one example of an estimation target image according to the example embodiment 1.

FIG. 4 is a diagram illustrating one example of a reference image according to the example embodiment 1.

FIG. 5 is a diagram illustrating a functional configuration example of the information processing apparatus according to the example embodiment 1.

FIG. 6 is a diagram illustrating one example of a similarity degree map according to the example embodiment 1.

FIG. 7 is a diagram illustrating a physical configuration example of the information processing apparatus according to the example embodiment 1.

FIG. 8 is a flowchart illustrating a detailed example of the information processing according to the example embodiment 1.

FIG. 9 is a flowchart illustrating a detailed example of extraction processing according to the example embodiment 1.

FIG. 10 is a diagram illustrating one example of a change in data size until a feature is acquired from an estimation target image according to the example embodiment 1.

FIG. 11 is a diagram schematically illustrating one example of a generation method of similarity degree information according to the example embodiment 1.

FIG. 12 is a flowchart illustrating one example of similarity degree generation processing according to the example embodiment 1.

FIG. 13 is a flowchart illustrating a detailed example of estimation processing according to the example embodiment 1.

FIG. 14 is a schematic diagram illustrating one example of a data size and a data configuration of a reference feature Rref according to an example embodiment 2.

FIG. 15 is a diagram illustrating a functional configuration example of an information processing apparatus according to an example embodiment 3.

FIG. 16 is a flowchart illustrating one example of information processing according to the example embodiment 3.

FIG. 17 is a diagram illustrating a functional configuration example of an information processing apparatus according to an example embodiment 4.

FIG. 18 is a flowchart illustrating one example of line-of-sight acquisition processing according to the example embodiment 4.

FIG. 19 is a diagram illustrating a functional configuration example of an information processing apparatus according to an example embodiment 5.

FIG. 20 is a flowchart illustrating one example of learning processing according to the example embodiment 5.

FIG. 21 is a flowchart illustrating one example of the learning processing according to the example embodiment 5.

FIG. 22 is a diagram illustrating a functional configuration example of an information processing apparatus according to an example embodiment 8.

FIG. 23 is a flowchart illustrating one example of display processing according to the example embodiment 8.

FIG. 24 is a diagram illustrating one example of a display image according to the example embodiment 8.

FIG. 25 is a diagram illustrating a configuration example of an information processing system according to an example embodiment 9.

### EXAMPLE EMBODIMENT

Hereinafter, example embodiments will be described by using drawings. Note that, in all of the drawings, a similar component has a similar reference sign, and description thereof will be appropriately omitted.

### Example Embodiment 1

### (Overview)

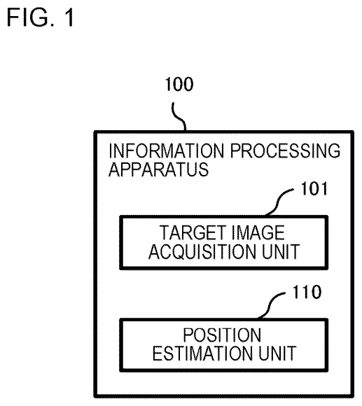

FIG. 1 is a diagram illustrating an overview of an information processing apparatus 100 according to an example embodiment 1. The information processing apparatus 100 includes a target image acquisition unit 101 and a position estimation unit 110.

The target image acquisition unit 101 acquires an estimation target image including an image of a target part in an estimation target.

The position estimation unit 110 extracts a target part feature related to a portion associated with the target part from a feature of the estimation target image, based on a learning result acquired by performing learning by using a reference image including an image of the target part and a target image including an image of the target part, and estimates a position of the target part, based on the target part feature.

The information processing apparatus 100 can accurately estimate a position of a target part.

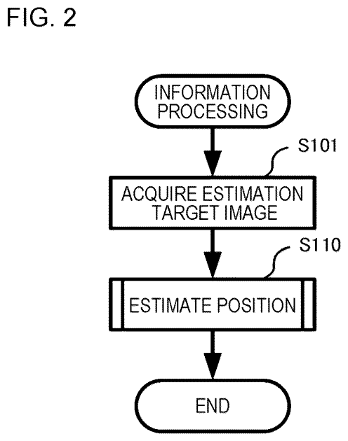

FIG. 2 is a diagram illustrating an overview of information processing according to the example embodiment 1.

The target image acquisition unit 101 acquires an estimation target image including an image of a target part in an estimation target (step S110).

The position estimation unit 110 extracts a target part feature related to a portion associated with the target part from a feature of the estimation target image, based on a learning result acquired by performing learning by using a reference image including an image of the target part and a target image including an image of the target part, and estimates a position of the target part, based on the target part feature (step S110).

The information processing can accurately estimate a position of a target part.

A detailed example of the example embodiment 1 will be described below.

### Detailed Example

For example, in the object tracking method described in Patent Document 1, a position of an object is detected by template matching. In the template matching, as described in Patent Document 1, a degree of similarity is computed in each position by shifting a relative positional relationship between a matching target region and a template, and a position of an object is detected based on the degree of similarity. However, in such template matching, it is difficult to detect a position of an object more specifically than a shift amount of a relative positional relationship.

Further, for example, in the technique described in Patent Document 2, even in a case where whether a second image is an image of a left eye or a right eye can be determined, a technique for accurately estimating a position of a target part such as, for example, a pupil is not disclosed.

A technique for accurately estimating a position of a target part such as a position of a pupil of a person is desired.

One example of an object of this disclosure is, in view of such a circumstance, to provide an information processing apparatus, an information processing method, a storage medium storing a program, and the like that achieve accurate estimation of a position of a target part.

The information processing device 100 is a device for estimating a position of a target part in an estimation target. The information processing apparatus 100 acquires an estimation target image including a target part in an estimation target, and estimates a position of the target part, based on a learning result acquired by performing learning by using a reference image and a target image.

The estimation target is a target in which a position of a target part is estimated. The target is, for example, a person, an object, and the like. In a case where the target is an object, the target is, for example, a machine, an animal, a plant, and the like. The machine is, for example, a robot, a car, a machine tool, and the like.

The estimation target according to the present example embodiment is a person.

The target part is an area predetermined as an area having a position estimated among areas included in the estimation target. In a case where the estimation target is a person, the target part is, for example, at least one of the center of a pupil (a pupil center), an outer corner of an eye, an inner corner of an eye, a tip of a nose, the center of a nostril, a corner of a mouth, and the like. Further, for example, for a plurality of areas provided on the left and the right, and the like of the estimation target, the target part may be predetermined by distinguishing between the left and the right such as a pupil center of a left eye and a pupil center of a right eye, and the like.

The target part according to the present example embodiment is a pupil center.

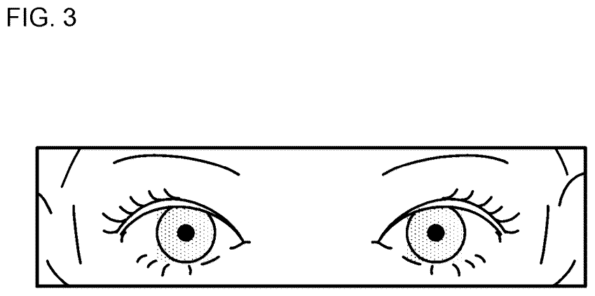

The estimation target image includes an image of the target part in the estimation target. FIG. 3 is a diagram illustrating one example of the estimation target image according to the present example embodiment. The estimation target image according to the present example embodiment is a both eyes image including both eyes of the estimation target. Note that, the estimation target image may be a one eye image.

Both of a reference image and a target image include an image of the target part.

The reference image is an image used as a reference for estimating a position of the target part in the estimation target, and is prepared in advance. The reference image is used in common in both cases of a case where learning for estimating a position of the target part in the estimation target is performed and a case where a position of the target part in the estimation target is estimated.

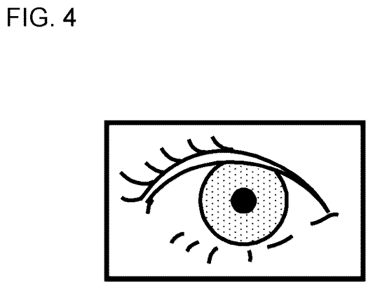

FIG. 4 is a diagram illustrating one example of the reference image according to the present example embodiment. In the present example embodiment, the reference image is a right eye image. The reference image may be an image of a right eye of an appropriate target (a person in the present example embodiment) different from the estimation target.

Further, the reference image may be an image generated by image processing and the like. For example, the reference image may be an average image acquired by averaging right eye images of a plurality of targets (persons in the present example embodiment).

Note that, the reference image may be an image including only a predetermined eye of a left eye and a right eye, and may be, for example, a left eye image. Further, the reference image may be a one eye image (an image in which a right eye image and a left eye image are mixed) including only any one of eyes.

The target image is an image used in a case where learning for estimating a position of the target part in the estimation target is performed. The target image according to the present example embodiment is a both eyes image including both eyes of a person similarly to the estimation target image. The target part included in the target image may be the target part of the estimation target or a target part of a target different from the estimation target.

### (Detailed Example of Functional Configuration of Information Processing Apparatus 100)

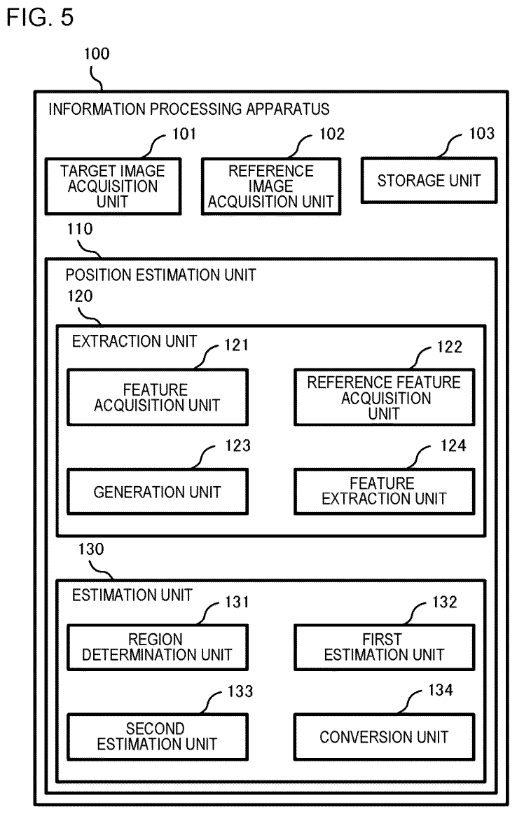

FIG. 5 is a diagram illustrating a functional configuration example of the information processing apparatus 100 according to the example embodiment 1.

The information processing apparatus 100 functionally includes the target image acquisition unit 101, a reference image acquisition unit 102, a storage unit 103, and the position estimation unit 110.

As described above, the target image acquisition unit 101 acquires an estimation target image.

The estimation target image is, for example, an image captured in real time. Examples of the estimation target image captured in real time can include an image captured for biometric authentication such as iris authentication and face authentication, and a surveillance image captured by a surveillance camera.

The target image acquisition unit 101 may acquire, via a communication network and the like from one or a plurality of capturing apparatuses such as, for example, a visible light camera and a near infrared camera that capture an estimation target, an estimation target image acquired from capturing by each of the capturing apparatuses. Further, for example, the target image acquisition unit 101 may acquire, via a communication network and the like, an estimation target image acquired from capturing by using a capturing apparatus mounted on a terminal apparatus (for example, a smartphone, a tablet terminal) used by an estimation target. The target image acquisition unit 101 may acquire a plurality of estimation target images for the same estimation target.

The reference image acquisition unit 102 acquires a reference image. For example, the reference image is stored in advance in the storage unit 103. In this case, the reference image acquisition unit 102 may acquire the reference image from the storage unit 103. Note that, the reference image acquisition unit 102 may acquire a reference image from another apparatus that is not illustrated via a communication network and the like.

The storage unit 103 stores various pieces of information. The information stored in the storage unit 103 may include, for example, a learning result acquired by performing learning by using a reference image and a target image. Further, for example, the information stored in the storage unit 103 may include a reference image acquired by the target image acquisition unit 101. Furthermore, for example, an estimation target image acquired by the target image acquisition unit 101 may be stored in the storage unit 103.

The learning result includes, for example, at least one of a feature extraction model and a position estimation model. A learning method of each of the feature extraction model and the position estimation model will be described in another example embodiment.

### Example 1 of Learning Result: Feature Extraction Model

The feature extraction model is a trained model subjected to machine learning for extracting a feature of an estimation target image.

For example, a feature of an estimation target image can be extracted by using the feature extraction model with the estimation target image as an input. Further, for example, a reference feature can be extracted by using the feature extraction model with a reference image as an input. The reference feature is a feature of the reference image.

The feature extraction model is, for example, a model including a convolutional neural network (CNN) typified by ResNet, VGGNet, GoogleNet, ResNext, SENet, EfficientNet, and the like, and the like. In this case, the feature is a so-called CNN feature.

### Example 2 of Learning Result: Position Estimation Model

The position estimation model is a trained model subjected to machine learning for estimating an in-region position. The in-region position indicates a position of a target part in an associated region. The associated region is a region associated with a target part feature. The target part feature is a part of a feature of an estimation target image, and is a feature related to a portion associated with the target part.

The associated region according to the present example embodiment is a region u included in similarity degree information described below. Note that, the associated region is not limited to this, and may be, for example, a region in an estimation target image, a region in a real space associated with the estimation target image, and the like.

For example, an in-region position of a target part in an estimation target can be estimated by using the position estimation model with a feature of an estimation target image as an input.

The position estimation model is, for example, a model including a linear regression model, a neural network (NN), a CNN, and the like.

### (Position Estimation Unit 110)

The position estimation unit 110 extracts a target part feature from a feature of an estimation target image, based on a learning result acquired by performing learning by using a reference image and a target image, and estimates a position of a target part in an estimation target, based on the target part feature.

In the present example embodiment, description is given by using an example in which the position estimation unit 110 estimates a pupil center of a right eye of an estimation target. Note that, the position estimation unit 110 may estimate a pupil center of both eyes included in an estimation target image, based on a reference image being a right eye image.

As illustrated in FIG. 5, the position estimation unit 110 includes an extraction unit 120 and an estimation unit 130.

### (Extraction Unit 120)

The extraction unit 120 generates similarity degree information described below, and extracts a target part feature from a feature of an estimation target image, based on the similarity degree information.

As illustrated in FIG. 5, the extraction unit 120 includes, for example, a feature acquisition unit 121, a reference feature acquisition unit 122, a generation unit 123, and a feature extraction unit 124.

The feature acquisition unit 121 acquires a feature of an estimation target image by using the feature extraction model with the estimation target image as an input.

The reference feature acquisition unit 122 acquires a reference feature being a feature of a reference image by using the feature extraction model with the reference image as an input. Note that, the reference feature may be stored in advance in the storage unit 103. In this case, the reference feature acquisition unit 122 may acquire the reference feature from the storage unit 103, and the reference image acquisition unit 102 may not be included in the information processing apparatus 100.

The generation unit 123 generates similarity degree information, based on the feature of the estimation target image, and the reference feature.

Specifically, for example, the generation unit 123 obtains a degree of similarity between each of a plurality of portions included in the feature of the estimation target image, and the reference feature. Each of the plurality of portions included in the feature is, for example, the same size as that of the reference feature. The degree of similarity is an indicator indicating a greater value as a portion of the feature and the reference feature are more similar. In the present example embodiment, the degree of similarity is a spatial cosine degree of similarity between a portion of the feature of the estimation target image and the reference feature.

Note that, the degree of similarity is not limited to this, and an indicator indicating a smaller value as a portion of the feature and the reference feature are more similar may be adopted.

### (Similarity Degree Information)

Similarity degree information is information indicating a degree of similarity between a feature of an estimation target image and a reference feature. For example, for each of a plurality of portions included in a feature, the similarity degree information includes a similarity degree map indicating, in association with each other, the region u associated with the portion, and a degree of similarity to a reference feature obtained for the portion.

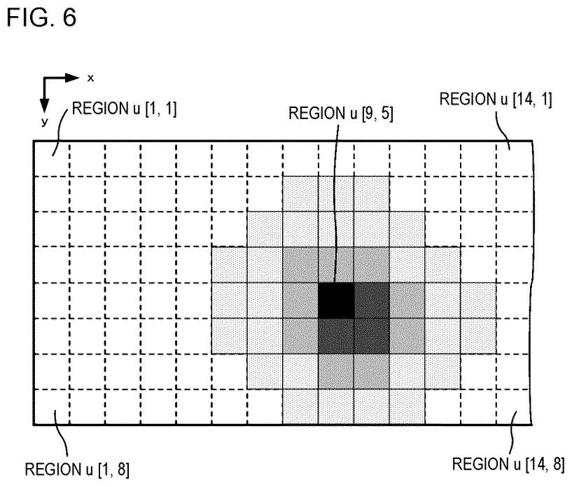

FIG. 6 is a diagram illustrating one example of the similarity degree map according to the present example embodiment. Note that, the similarity degree map may be information that associates the region u associated with each of a plurality of portions included in a feature with a degree of similarity for the portion, and may be indicated by, for example, a table that associates a position of the region u with a degree of similarity, and the like.

In the present example embodiment, the reference image is a right eye image, and thus a degree of similarity of the region u associated with a vicinity of a pupil of a right eye of an estimation target increases. Thus, FIG. 6 illustrates and enlarges the vicinity of the pupil of the right eye of an entire region of the similarity degree map.

The entire region of the similarity degree map is associated with the entire feature of the estimation target image. Further, the similarity degree map is formed of a plurality of the regions u (small substantially square regions surrounded by a dotted line in FIG. 6) acquired by dividing the similarity degree map. As described below in detail, each of the regions u is associated with each of a plurality of portions included in the feature of the estimation target image on a one-to-one basis.

In the present example embodiment, description is given by using an example in which the entire region of the similarity degree map is formed of the regions u including 32 regions u arranged in an x direction (horizontal direction in FIG. 6) and 8 regions u arranged in a y direction (vertical direction in FIG. 6). Further, in the present example embodiment, description is given by using an example in which each of the regions u is identified by a number located in a direction of each of the x direction and the y direction being counted from the upper left of the region map illustrated in FIG. 6. Specifically, the region u in an i-th position (i is an integer from 1 to 32) in the x direction and a j-th position (j is an integer from 1 to 32) in the y direction being counted from the upper left illustrated in FIG. 6 is represented as the region u [i,j]. In other words, FIG. 6 illustrates the region u having i from 1 to 14 of the entire region.

In the similarity degree map illustrated in FIG. 6, the plurality of regions u are represented by depth (gray scale) according to a degree of similarity between a portion of the feature associated with each of the regions u and the reference feature. The region u is painted in more depth as the degree of similarity associated with the region u is greater. In the similarity degree map illustrated in FIG. 6, for example, the region u painted in most depth is the region u [9,5], which represents that the degree of similarity of the region u [9,5] is maximum.

In this way, in the similarity degree map, the region u associated with each of a plurality of portions included in the feature and the degree of similarity are associated with each other.

Note that, the region u constituting the entire region of the similarity degree map may be a rectangle other than a square, and may be another shape. Further, a method for identifying the number of regions u constituting the entire region and each of the regions u, and the like may be appropriately changed. Furthermore, a degree of similarity in the similarity degree map is not limited to depth by gray scale, and may be represented by using a degree of similarity itself (i.e., a value), an indicator by stage associated with a degree of similarity, at least one of color and depth, and the like. The indicator may be a character, a symbol, a number, and the like.

FIG. 5 is referred again.

The feature extraction unit 124 extracts a target part feature from the feature of the estimation target image, based on the similarity degree information.

Specifically, for example, the feature extraction unit 124 extracts a target part feature from the feature of the estimation target image, based on a predetermined determination condition and the similarity degree information.

The determination condition is a condition for determining an associated region from the regions u included in the similarity degree information. The determination condition according to the present example embodiment is a condition that the region u has a maximum degree of similarity. It can be said that the associated region is the region u having a high possibility of being associated with a target part (a pupil center in the present example embodiment).

Note that, the determination condition is not limited to this, and may be, for example, a condition of being equal to or more than a threshold value related to a degree of similarity, and the like. Further, a plurality of associated regions may be determined based on the determination condition.

The feature extraction unit 124 according to the present example embodiment determines a maximum degree of similarity from the similarity degree information according to the determination condition. Then, the feature extraction unit 124 extracts a portion associated with the determined degree of similarity from the feature of the estimation target image. The portion of the feature being extracted by this is a target part feature.

In other words, in the present example embodiment, the target part feature is the portion associated with the determined degree of similarity of the feature of the estimation target image. That is to say, the portion associated with the determined degree of similarity is a portion used for obtaining the determined degree of similarity. Thus, the similarity degree information may further include information that associates a degree of similarity with a portion of a feature used for obtaining the degree of similarity.

### (Estimation Unit 130)

The estimation unit 130 estimates an in-region position by using the position estimation model with the target part feature as an input, and estimates a position of the target part, based on the in-region position.

As illustrated in FIG. 5, the estimation unit 130 includes, for example, a region determination unit 131, a first estimation unit 132, a second estimation unit 133, and a conversion unit 134.

The region determination unit 131 determines a region position. The region position indicates a position of the region u (associated region) being associated with the target part feature.

For example, the region determination unit 131 may determine, as an associated region, the region u associated with the target part feature extracted by the feature extraction unit 124, based on the similarity degree information, and may determine a position of the associated region. Further, for example, the region determination unit 131 may determine an associated region, based on the determination condition and the similarity degree information. In this case, the determination condition according to the present example embodiment is a condition that the region u has a maximum degree of similarity, and thus the region determination unit 131 may refer to the similarity degree information, and determine a position of the region u associated with the maximum degree of similarity as a position of the associated region.

A position determined by the region determination unit 131 is represented by, for example, a position in the similarity degree information (i.e., a position in an x-y coordinate system described with reference to FIG. 6). In the present example embodiment, description is given by using an example in which, in a case where the associated region is the region u [i, j], a position of the associated region is represented as [i, j].

Note that, a position determined by the region determination unit 131 is not limited to a position in the similarity degree information, and may be represented by, for example, a position in an estimation target image, or a position in a real space associated with the estimation target image.

The first estimation unit 132 estimates an in-region position by using the position estimation model with the target part feature as an input.

The target part feature input to the position estimation model is the target part feature extracted by the feature extraction unit 124. An in-region position estimated by the first estimation unit 132 is represented by, for example, a position in the associated region. The position in the associated region is represented by, for example, a difference from a representative position in the region u being the associated region.

The representative position in the region u is a position predetermined for the region u, and is, for example, the center, any of four corners such as a lower right corner, and the like of the region u. Further, the difference is a value in the coordinate system in the similarity degree information. Specifically, for example, it is assumed that the coordinate system in the similarity degree information is the x-y coordinate system in which an upper left corner of the entire similarity degree map illustrated in FIG. 6 is the origin, and a representative position is the lower right corner. In this case, a position of the region u [i, j] in the x-y coordinate system can be represented as (i, j). Further, each of Δx and Δy representing an in-region position (Δx, Δy) is a value equal to or more than −1 and less than 0.

Note that, in a case where a representative position is the center of the region u, each of Δx and Δy representing the in-region position (Δx, Δy) is, for example, a value equal to or more than −0.5 and equal to or less than +0.5. For example, in a case where a representative position is an upper left corner, each of Δx and Δy representing the in-region position (Δx, Δy) is, for example, a value equal to or more than 0 and less than 1.

Note that, the difference may be represented by using a value in a coordinate system in an estimation target image, or a value in a coordinate system in a real space associated with the estimation target image.

The second estimation unit 133 estimates a position of the target part of the estimation target in the entire region, based on the region position determined by the region determination unit 131 and the in-region position estimated by the first estimation unit 132.

A position estimated by the second estimation unit 133 is represented by, for example, a position in the similarity degree information (i.e., a position in the x-y coordinate system described above). Note that, a position estimated by the second estimation unit 133 is not limited to a position in the similarity degree information, and may be represented by, for example, a position in an estimation target image, or a position in a real space associated with the estimation target image.

The conversion unit 134 converts the coordinate system of the entire region, and thus converts the position estimated by the second estimation unit 133 into a position in the estimation target image of the target part of the estimation target.

As described above, in the present example embodiment, a position estimated by the second estimation unit 133 is represented by a position in the similarity degree information. For example, the conversion unit 134 performs coordinate conversion on a position estimated by the second estimation unit 133, and thus obtains a position associated with the position estimated by the second estimation unit 133 in the estimation target image.

Note that, in a case where the second estimation unit 133 estimates a position in the estimation target image, the conversion unit 134 may not be included in the estimation unit 130. Further, the conversion unit 134 may convert a position estimated by the second estimation unit 133 into a position in a real space associated with the estimation target image.

The functional configuration example of the information processing apparatus 100 according to the present example embodiment is described above. Hereinafter, a physical configuration example of the information processing apparatus 100 according to the present example embodiment will be described.

### (Physical Configuration Example of Information Processing Apparatus 100)

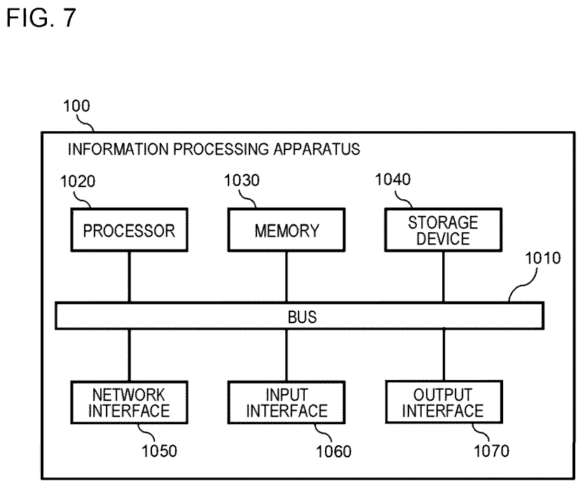

FIG. 7 is a diagram illustrating a physical configuration example of the information processing apparatus 100 according to the present example embodiment.

The information processing apparatus 100 functionally includes a bus 1010, a processor 1020, a memory 1030, a storage device 1040, a network interface 1050, an input interface 1060, and an output interface 1070.

The bus 1010 is a data transmission path for allowing the processor 1020, the memory 1030, the storage device 1040, the network interface 1050, the input interface 1060, and the output interface 1070 to transmit and receive data to and from one another. However, a method for connecting the processor 1020 and the like to one another is not limited to bus connection.

The processor 1020 is a processor achieved by a central processing unit (CPU), a graphics processing unit (GPU), and the like. The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module for achieving each function of the information processing apparatus 100. The processor 1020 reads each program module onto the memory 1030 and executes the program module, and a function associated with the program module is achieved.

The network interface 1050 is an interface for connecting the information processing apparatus 100 to a communication network. The input interface 1060 is an interface for a user to input information, and includes, for example, a touch panel, a keyboard, a mouse, and the like. The output interface 1070 is an interface for providing information to a user, and includes, for example, a liquid crystal panel, an organic electro-luminescence (EL) panel, and the like.

Note that, the information processing apparatus 100 may be formed of a plurality of apparatuses having a configuration functionally similar to that of the information processing apparatus 100 illustrated in FIG. 7, for example. In this case, the plurality of apparatuses may be formed in such a way as to be able to transmit and receive information to and from one another via a communication network and the like.

The physical configuration example of the information processing apparatus 100 according to the present example embodiment is described above. Hereinafter, an operation example of the information processing apparatus 100 according to the present example embodiment will be described.

### (Operation Example of Information Processing Apparatus 100)

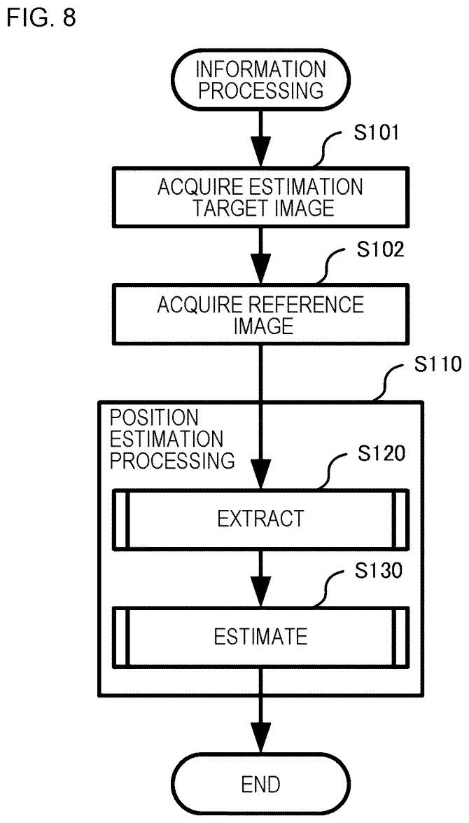

FIG. 8 is a flowchart illustrating a detailed example of the information processing according to the present example embodiment. The information processing is processing for estimating a position of a target part in an estimation target.

For example, the information processing starts by a capturing apparatus capturing an estimation target. The capturing apparatus may capture an estimation target in a state of standing in front of the capturing apparatus, or may performing capturing at a point in time at which a walking estimation target reaches a focus point.

Further, for example, the capturing apparatus may continuously perform capturing at a predetermined time interval, and, in this case, the information processing may be repeatedly performed.

As illustrated in FIG. 8, the target image acquisition unit 101 acquires an estimation target image (step S101).

Specifically, for example, the target image acquisition unit 101 acquires the estimation target image as illustrated in FIG. 3. Such an estimation target image can be acquired by, for example, installing the capturing apparatus in such a way that the capturing apparatus captures a vicinity of both eyes of an estimation target.

Further, for example, the target image acquisition unit 101 may cut a predetermined portion such as a face of the estimation target out of a captured image. In this case, for example, the target image acquisition unit 101 may detect a both eyes image from a face image by using predetermined pattern matching having a relatively light processing load, and the like, and cut the detected both eyes image out of the face image.

The estimation target image is desirably a high-definition image having a relatively great number of images, and is, for example, an image having 1000 pixels (px) vertically and 4000 px horizontally.

Although not illustrated herein, the target image acquisition unit 101 may decide, by using pattern matching and the like, whether the both eyes image being the estimation target image is included in the image acquired from the capturing apparatus in step S101. Then, in a case where it is decided that the estimation target image is included, step S102 described below may be performed. Further, in a case where it is decided that the estimation target image is not included, the target image acquisition unit 101 may repeatedly perform step S101.

As illustrated in FIG. 8, the reference image acquisition unit 102 acquires a reference image (step S102).

Specifically, for example, the reference image acquisition unit 102 acquires a reference image from the storage unit 103. The reference image is, for example, the right eye image as illustrated in FIG. 4.

The position estimation unit 110 performs the position estimation processing (step S110) described above. In other words, in step S110, the position estimation unit 110 extracts a target part feature from a feature of the estimation target image, based on a learning result acquired by performing learning by using the reference image and a target image, and estimates a position of a target part in the estimation target, based on the target part feature.

As illustrated in FIG. 8, the position estimation processing (step S110) includes extraction processing (step S120) and estimation processing (step S130).

The extraction unit 120 generates similarity degree information, and extracts the target part feature from the feature of the estimation target image, based on the similarity degree information (step S120).

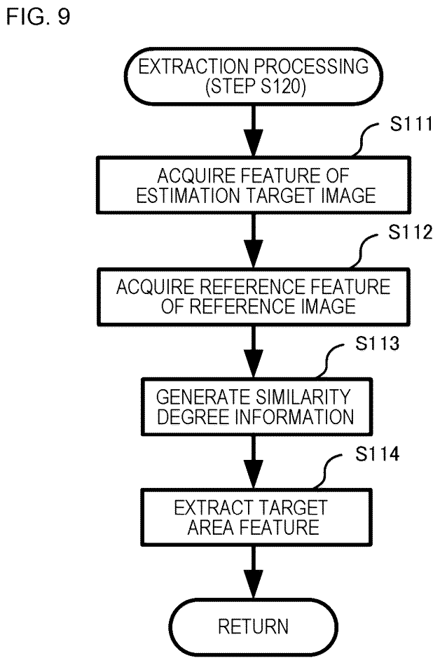

FIG. 9 is a flowchart illustrating a detailed example of the extraction processing (step S120) according to the present example embodiment.

The feature acquisition unit 121 acquires the feature of the estimation target image by using the feature extraction model with the estimation target image acquired in step S101 as an input (step S111).

Specifically, for example, the feature acquisition unit 121 reduces a size of the estimation target image in order to reduce a processing load, enhance a speed of processing, and the like.

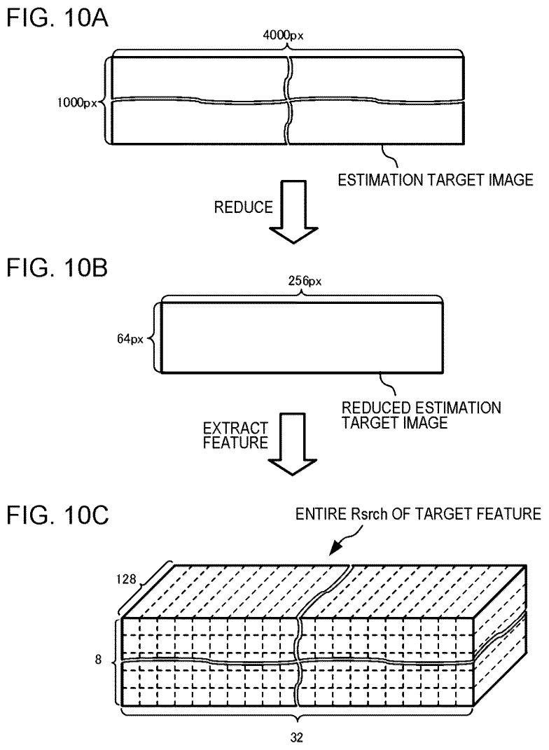

Herein, FIG. 10 is a diagram illustrating one example of a change in data size until a feature is acquired from an estimation target image according to the present example embodiment. FIG. 10(a) illustrates an example of a data size of the estimation target image acquired in step S101. FIG. 10(b) illustrates an example of a data size of a reduced estimation target image. FIG. 10(c) illustrates an example of a data size of a feature of the estimation target image.

As illustrated in FIGS. 10(a) and 10(b), the feature acquisition unit 121 reduces the data size of the estimation target image from 1000 px×4000 px to 64 px×256 px, for example. In this example, aspect ratios before and after the reduction are the same. Note that, a reduction ratio in reduction processing may be appropriately changed, and the reduction processing may not be performed.

The feature acquisition unit 121 acquires a feature of the estimation target image by using the feature extraction model with the reduced estimation target image as an input. The feature is, for example, a CNN feature, and is three-dimensional data including a dimension of a channel number. In a case where a data size of the feature is represented by Csrch×Hsrch×Wsrch with a channel number as Csrch, a length as Hsrch, and a width (horizontal) as Wsrch, the data size are 128×8×32 as illustrated in FIG. 10(c) in the present example embodiment.

Note that, the data size of the feature of Csrch×Hsrch×Wsrch may be appropriately changed. Further, an aspect ratio (for example, Hsrch/Wsrch) of the feature is the same as that of the estimation target image in the example described above, but may be different from that of the estimation target image.

The reference feature acquisition unit 122 acquires a reference feature by using the feature extraction model with the reference image acquired in step S102 as an input (step S112).

The feature extraction model used in step S112 may be the same as the feature extraction model used in step S111. The reference feature is, for example, three-dimensional data including a dimension of a channel number similarly to the feature of the estimation target image. In a case where a data size of the reference feature is represented by Cref×Href×Wref with a channel number as Cref, a length as Href, and a width (horizontal) as Wref, the data size are 128×3×11 in the present example embodiment. In other words, the channel number Cref of the reference feature is the same as the channel number Csrch of the feature.

Note that, description is given by using an example in which a size of length and width of the reference feature is 3×11, but a size of length and width of the reference feature may be appropriately changed. Further, the feature and the reference feature may have different channel numbers.

Further, in a case where the storage unit 103 stores the reference feature, the reference feature acquisition unit 122 may acquire the reference feature from the storage unit 103 in step S112, and step S102 may not be performed.

FIG. 9 is referred again.

The generation unit 123 generates similarity degree information, based on the feature of the estimation target image acquired in step S111, and the reference feature acquired in step S112 (step S113).

### (Generation Method of Similarity Degree Information)

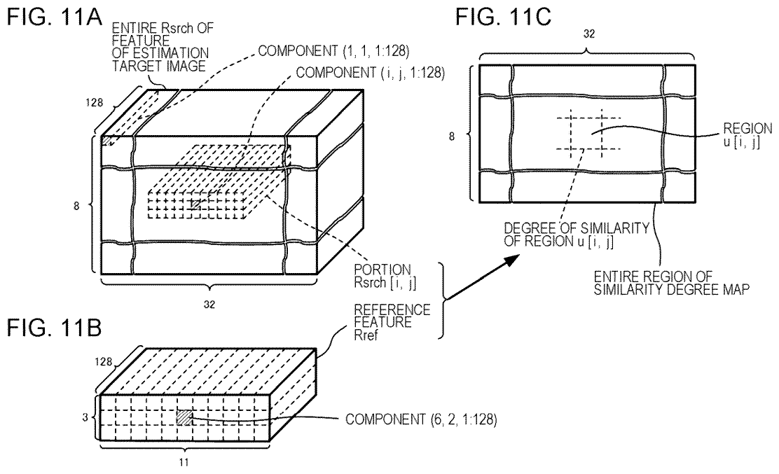

An overview of a method for generating similarity degree information (similarity degree map) will be described with reference to FIG. 11. FIG. 11 is a diagram schematically illustrating one example of the generation method of similarity degree information according to the present example embodiment. FIG. 11(a) is a diagram illustrating one example of a relationship between an entire Rsrch and a portion of the feature of the estimation target image. FIG. 11(b) is a diagram illustrating one example of a data size of a reference feature Rref. FIG. 11(c) is a diagram illustrating one example of a relationship between an entire region of the similarity degree map and the region u.

The generation unit 123 extracts a portion Rsrch [i, j] having the same data size as that of the reference feature Rref illustrated in FIG. 11(b) from the entire Rsrch of the feature of the estimation target image. Herein, as described above, i is an integer from 1 to 32, and j is an integer from 1 to 8.

Each of the portions Rsrch [i, j] is a portion different from each other of the entire Rsrch of the feature of the estimation target image.

Specifically, for example, the generation unit 123 extracts the portion Rsrch [i, j] in such a way that each component (i, j, 1:128) of matrices representing the entire Rsrch coincides with a center component as the reference feature Rref is viewed from a channel direction.

In the present example embodiment, since the portion Rsrch [i, j] has the same data size as that of the reference feature Rref, the portion Rsrch [i, j] is formed of a component (i−5:i+5, j−1:j+1, 1:128) of the components constituting the entire Rsrch. Further, in the present example embodiment, the center component as the reference feature Rref is viewed from the channel direction is a component (2, 6, 1:128).

Herein, in a case where [:] represents a range and any integer is p, q(q>p), “p:q” represents an integer from p to q. In other words, for example, the component (2, 6, 1:128) represents a component located in (2, 6) as the entire Rsrch is viewed from the channel direction, i.e., an entire component (2, 6, r) in a case where r is an integer from 1 to 128.

As a result of such extraction processing, Rsrch [i, j] and Rsrch [i+1, j] being portions adjacent to each other in a width direction are portions shifted by one component in a horizontal direction in the entire Rsrch. Further, Rsrch [i, j] and Rsrch [i, j+1] being portions adjacent to each other in a vertical direction are portions shifted by one component in the vertical direction in the entire Rsrch.

In the extraction processing, in a case where a part of a component constituting the portion Rsrch [i, j] is not included in the entire Rsrch such as, for example, a case where i=1 and j=1, the values may be values acquired by interpolating the outside of the entire Rsrch. In the interpolation processing, various types of padding processing such as, for example, Zero Padding, Reflection Padding, and Replication Padding may be used.

Note that, a method for extracting the portion Rsrch [i, j] by the entire Rsrch may be appropriately changed, and, for example, a shift amount of portions adjacent to each other in the width direction and the vertical direction is not limited to one component and may be appropriately determined in each of the directions.

The generation unit 123 obtains a spatial cosine degree of similarity between each of the extracted portions Rsrch [i, j] and the reference feature Rref. In this way, the generation unit 123 acquires a degree of similarity of the region u [i, j] of the entire region of the similarity degree map illustrated in FIG. 11(c).

The cosine degree of similarity is obtained by using Equation (1), for example. In Equation (1), u represents the position [i, j]. In other words, in Equation (1), Map [u] and cos θ [u] represent a degree of similarity of the region u [i, j]. Rsrch [u] represents a feature of the portion Rsrch [i, j]. The cosine degree of similarity obtained by using Equation (1) in the present example embodiment is represented by, for example, a one-dimensional vector including 4224 (=128×3×11) components.

$$\begin{matrix}[ Mathematical 1 ] & \\ Map [ u ] = \frac{Rref * Rsrch [ u ]}{\vert \vert Rref \vert \vert * \vert \vert Rsrch [ u ] \vert \vert} = cos θ [ u ] & ( 1 )\end{matrix}$$

For example, the generation unit 123 may obtain the cosine degree of similarity for the portion Rsrch [i, j] each time the portion Rsrch [i, j] is extracted. Further, for example, the generation unit 123 may obtain the cosine degree of similarity for each of the portions Rsrch [i, j] after all of the portions Rsrch [i, j] are extracted.

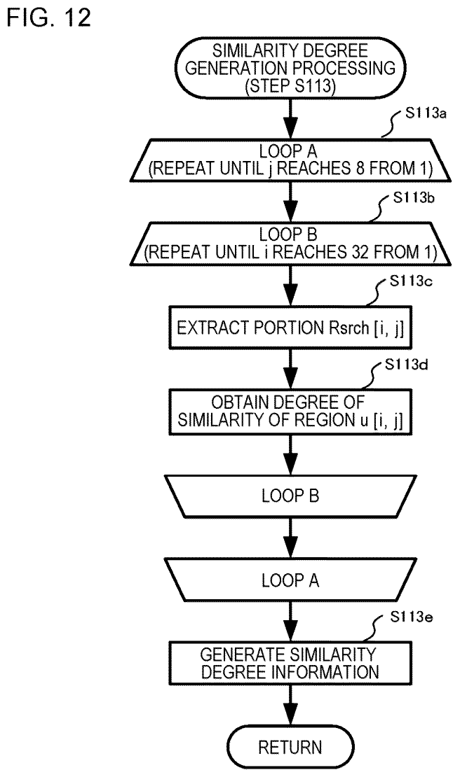

FIG. 12 is a flowchart illustrating one example of similarity degree generation processing (step S113) according to the present example embodiment. The flowchart illustrated in FIG. 12 illustrates one example of obtaining a cosine degree of similarity for the portion Rsrch [i, j] each time the portion Rsrch [i, j] is extracted.

The generation unit 123 repeatedly performs steps S113b to S113d until j reaches 8 from 1 (step S113a; loop A). The generation unit 123 repeatedly performs steps S113c to S113d until i reaches 32 from 1 (step S113b; loop B).

The generation unit 123 extracts the portion Rsrch [i, j] having the same data size as that of the reference feature Rref from the entire Rsrch by performing interpolation on surroundings of the entire Rsrch as necessary (step S113c). The generation unit 123 obtains a spatial cosine degree of similarity between the portion Rsrch [i, j] extracted in step S113c and the reference feature Rref by using, for example, Equation (1) described above (step S113d).

The generation unit 123 generates similarity degree information (step S113d).

As clear from the procedures in steps S113a to 113d, the region u [i, j] and each degree of similarity are associated with the portion Rsrch [i, j] of the feature of the estimation target image on a one-to-one basis. In step S113d, the generation unit 123 generates, for example, the similarity degree information that further associates the region u [i, j] and each degree of similarity with the feature of the portion Rsrch [i, j] and the like.

Note that, the generation method of similarity degree information described herein is one example. A degree of similarity between each portion (portion having the same data size as that of the reference feature Rref) Rsrch [i, j] extracted from the entire Rsrch of the feature of the estimation target image according to predetermined vertical and horizontal slide amounts may be able to be obtained. A specific method for that may be appropriately changed. Further, a degree of similarity included in similarity degree information is not limited to a degree of similarity between features and may be a degree of similarity based on pixel values of a portion of an estimation target image and a reference image, and the like.

FIG. 9 is referred again.

The feature extraction unit 124 extracts a target part feature from the feature of the estimation target image, based on the similarity degree information generated in step S113 (step S114).

Specifically, for example, the feature extraction unit 124 extracts a target part feature from the entire Rsrch of the feature of the estimation target image, based on a determination condition and the similarity degree information. In a case where a region having a maximum degree of similarity is defined as the determination condition, the feature extraction unit 124 determines a maximum value of a degree of similarity (maximum degree of similarity) from the similarity degree information. Then, the feature extraction unit 124 extracts, as the target part feature, a portion associated with the determined maximum degree of similarity from the entire Rsrch of the feature of the estimation target image.

As described above, a degree of similarity included in the similarity degree information is associated with the portion Rsrch [i, j] of the feature of the estimation target image on a one-to-one basis. In the present example embodiment, the feature extraction unit 124 extracts, as the target part feature, the portion Rsrch [i, j] associated with a maximum degree of similarity.

In the example of the similarity degree information (similarity degree map) illustrated in FIG. 6, the degree of similarity of the region u [9, 5] in most depth (blackest) is maximum. In this case, the feature extraction unit 124 extracts, as the target part feature, the portion Rsrch [9, 5] of the feature of the estimation target image associated with the maximum degree of similarity. The portion Rsrch [9, 5] is formed of a component (4:14, 4:6, 1:128) of the components constituting the entire Rsrch.

Note that, in the present example embodiment, description is given by using the example in which any of the portions Rsrch [i, j] is extracted as the target part feature, but the target part feature may be a portion associated with a maximum degree of similarity of the entire Rsrch of the feature of the estimation target image. For example, a portion of the target part feature may have a predetermined data size different from that of the portion Rsrch [i, j] according to the present example embodiment. For example, the target part feature in this case may have the center common to the portion Rsrch [i, j] associated with the maximum degree of similarity and may be formed of a component (i−s:i+s, j+t:j−t, 1:128) of the components constituting the entire Rsrch. s and t herein represent any integer equal to or more than 0.

After the feature extraction unit 124 performs step S114, the processing returns to the position estimation processing (step S110).

FIG. 8 is referred again.

The estimation unit 130 estimates an in-region position by using the position estimation model with, as an input, the target part feature extracted in step S114, and estimates a position of the target part, based on the in-region position (step S130).

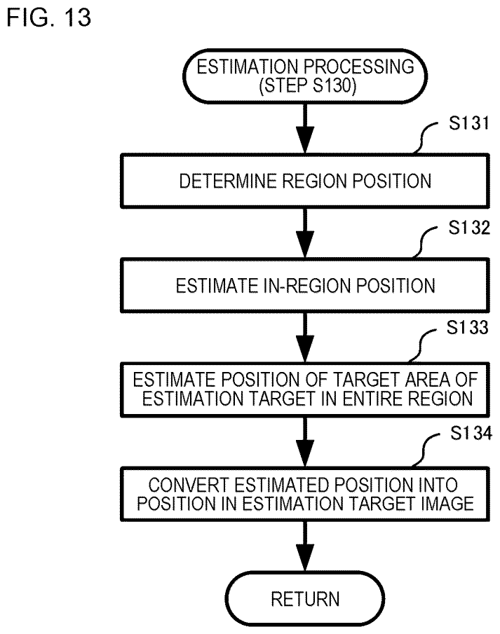

FIG. 13 is a flowchart illustrating a detailed example of the estimation processing (step S130) according to the present example embodiment.

The region determination unit 131 determines a region position (step S131).

Specifically, for example, the region determination unit 131 determines, as an associated region, the region u [i, j] associated with the target part feature extracted in step S114, based on the similarity degree information generated in step S113. Then, then region determination unit 131 determines a position of the determined associated region.

As in the example described above, in a case where the target part feature is the portion Rsrch [9, 5], the region determination unit 131 determines a representative position (i.e., for example, a ninth position in the horizontal direction and a fifth position in the vertical direction) of the region u [9, 5] associated with the target part feature. In a case where the representative position is the lower right corner of the region u [i, j], the region determination unit 131 obtains, as the representative position of the region u [9, 5], a position (9, 5) in the x-y coordinate system.

The first estimation unit 132 estimates an in-region position by using the position estimation model with, as an input, the target part feature extracted in step S114 (step S132).

Specifically, for example, in a case where the target part feature is the portion Rsrch [9, 5], the portion Rsrch [9, 5] is formed of the component (4:14, 4:6, 1:128) of the components constituting the entire Rsrch. Thus, the first estimation unit 132 uses, for an input f, the component (4:14, 4:6, 1:128) of the components constituting the entire Rsrch. Then, for example, the first estimation unit 132 obtains a difference (Δx, Δy) (=Wf) by using a linear regression model W with the component (4:14, 4:6, 1:128) as the input f. The difference is a difference from the representative position in the region u [9, 5] being the associated region.

Note that, the linear regression model W may be configured to output the difference (Δx, Δy) with a target part feature having a predetermined data size as an input.

The second estimation unit 133 estimates a position of the target part of the estimation target in the entire region, based on the region position determined in step S131 and the in-region position estimated in step S132 (step S133).

Specifically, for example, the second estimation unit 133 adds an associated x component and an associated y component of the difference (Δx, Δy) to each of an x component and a y component of the region position determined in step S131. In this way, the second estimation unit 133 obtains an estimated value of the position of the target part of the estimation target in the entire region. In a case where the representative position is set in the lower right corner of the region u as in the example described above and the position (9, 5) is determined in step S131, the second estimation unit 133 adds the difference (Δx, Δy) to the position and obtains the estimated value (9+Δx, 5+Δy).

The conversion unit 134 converts the coordinate system (x-y coordinate system) of the entire region, and thus converts the position estimated in step S132 into a position in the estimation target image of the target part of the estimation target (step S134).

Specifically, for example, as clear by referring to FIGS. 10 and 11 in the present example embodiment, a data size of the estimation target image in the entire region is reduced vertically and horizontally by 8/1000 times and 32/4000 times, respectively. In response to this, the conversion unit 134 multiplies each component of the position estimated in step S132 by a reciprocal of each of vertical and horizontal reduction ratios. In other words, the conversion unit 134 multiplies an x component of the estimated position by 4000/32, and multiplies a y component of the estimated position by 1000/8. In this way, the conversion unit 134 obtains the position of the target part of the estimation target in the estimation target image.

After the conversion unit 134 performs step S134, the processing returns to the position estimation processing (step S110), and the information processing ends as illustrated in FIG. 8. By performing the information processing, a position of a target part can be obtained with higher accuracy than a region position.

The example embodiment 1 of the this disclosure is described above.

### Action and Effect

According to the present example embodiment, the information processing apparatus 100 includes the target image acquisition unit 101 and the position estimation unit 110. The target image acquisition unit 101 acquires an estimation target image including an image of a target part in an estimation target. The position estimation unit 110 extracts a target part feature related to a portion associated with the target part from a feature of the estimation target image, based on a learning result acquired by performing learning by using a reference image including an image of the target part and a target image including an image of the target part, and estimates a position of the target part, based on the target part feature.

In this way, a position of a target part is estimated based on a target part feature, and thus a position of the target part can be obtained with higher accuracy than a region position. Therefore, a position of a target part can be accurately estimated.

According to the present example embodiment, the position estimation unit 110 includes the extraction unit 120 that generates similarity degree information indicating a degree of similarity between a feature of an estimation target image and a reference feature being a feature of a reference image, and extracts a target part feature from the feature of the estimation target image, based on the similarity degree information.

In this way, a target part feature is extracted based on similarity degree information indicating a degree of similarity between a feature of an estimation target image and a reference feature. The degree of similarity between the feature of the estimation target image and the reference feature has a relatively light processing load and can be performed at a high speed. Therefore, a position of a target part can be quickly and accurately estimated.

The extraction unit 120 includes the generation unit 123 and the feature extraction unit 124. The generation unit 123 generates similarity degree information, based on a feature of an estimation target image, and a reference feature. The feature extraction unit 124 extracts a target part feature from the feature of the estimation target image, based on the similarity degree information.

In this way, a target part feature is extracted based on similarity degree information indicating a degree of similarity between a feature of an estimation target image and a reference feature. The degree of similarity between the feature of the estimation target image and the reference feature has a relatively light processing load and can be performed at a high speed. Therefore, a position of a target part can be quickly and accurately estimated.

According to the present example embodiment, a learning result includes a learned feature extraction model subjected to machine learning for extracting a feature of an estimation target image. The extraction unit 120 further includes the feature acquisition unit 121 that acquires a feature of an estimation target image by using the feature extraction model with the estimation target image as an input.

In this way, a feature of an estimation target image is acquired by using the feature extraction model being a learning result. The processing for acquiring a feature of an estimation target image by using the feature extraction model has a relatively light processing load and can be performed at a high speed. Therefore, a position of a target part can be quickly and accurately estimated.

According to the present example embodiment, a learning result includes a learned position estimation model subjected to machine learning for estimating an in-region position indicating a position of a target part in an associated region being associated with a target part feature. The position estimation unit 110 includes the estimation unit 130 that estimates an in-region position by using the position estimation model with a target part feature as an input, and estimates a position of a target part, based on the in-region position.

In this way, an in-region position is estimated by using the position estimation model being a learning result, and a position of a target part is estimated based on the in-region position. The processing for estimating an in-region position by using the position estimation model with a target part feature as an input has a relatively light processing load and can be performed at a high speed.

Further, an in-region position indicates a position of a target part in an associated region being associated with a target part feature, i.e., a position inside the associated region. Thus, a position of a target part can be estimated more accurately than a case where a position an associated region is adopted as an estimation result of a position of a target part.

Therefore, a position of a target part can be quickly and accurately estimated.

According to the present example embodiment, the estimation unit 130 includes the region determination unit 131, the first estimation unit 132, and the second estimation unit 133. The region determination unit 131 determines a region position indicating a position of an associated region. The first estimation unit 132 estimates an in-region position by using the position estimation model with a target part feature as an input. The second estimation unit 133 estimates a position of a target part, based on the region position and the in-region position.

In this way, a position of a target part is estimated based on a region position and an in-region position. The processing has a relatively light processing load and can be performed at a high speed. Therefore, a position of a target part can be quickly and accurately estimated.

Further, by estimating a position of a target part, based on a region position and an in-region position, the position of the target part in an entire region can be acquired. In this way, the position of the target part in the entire region can be easily recognized. Therefore, convenience can be improved.

According to the present example embodiment, the estimation unit 130 further includes the conversion unit 134 that converts an estimated position of a target part into a position in an estimation target image.

In this way, the estimated position of the target part can be reflected in the estimation target image. Therefore, convenience can be improved.

According to the present example embodiment, a target part includes at least one of a pupil center, an outer corner of an eye, and an inner corner of an eye.

In this way, a position of various target parts can be accurately estimated.

According to the present example embodiment, an estimation target is a person. A target part is a pupil center. A reference image is a one eye image including only a predetermined eye. A target image is a both eyes image including both eyes. A degree of similarity is a spatial cosine degree of similarity.

The processing using these can be easily performed by using Equation (1) and the like. Therefore, a position of a target part can be easily and accurately estimated. Particularly, a position of a pupil center can be easily and accurately estimated. The pupil center is useful for cutting out an iris image used in iris authentication and the like, and an improvement in accuracy of the iris authentication can be achieved.

### Modification Example 1

The conversion unit 134 may cut out, of an estimation target image, an image of an interest region in a range predetermined with reference to a target part (for example, a pupil center) of an estimation target in an estimation target image, based on a position of the target part. The interest region is, for example, an iris. For example, the conversion unit 134 may output an image of the interest region to an authentication apparatus that performs iris authentication via a network and the like. In this way, a possibility that an image including an iris can be accurately acquired increases, and thus accurate authentication can be achieved.

### Modification Example 2

A target part may be, for example, any one or a plurality of an eye, a nose, a mouth, and the like. In this case, a reference image, a target image, and an estimation target image may be a face image. The estimation target image may include a background and the like. According to the present modification example, similarly to the example embodiment 1, a position of a target part in an estimation target can also be accurately estimated.

For example, as described in the modification example 1, the conversion unit 134 may cut out, of an estimation target image, a face image by regarding a face as an interest region, based on an estimated position of a target part. Then, for example, the conversion unit 134 may output the image of the interest region to an authentication apparatus that performs face authentication via a network and the like. In this way, a possibility that a face image including a face can be accurately acquired increases, and thus accurate authentication can be achieved.

### Example Embodiment 2

In the example embodiment 1, the example in which a target part is a pupil center is described. However, a plurality of target parts may be predetermined. Such target parts are a plurality of target parts among, for example, the center of a pupil (a pupil center), an outer corner of an eye, an inner corner of an eye, a tip of a nose, the center of a nostril, a corner of a mouth, and the like.

In the present example embodiment, a point different from the example embodiment 1 will be mainly described and overlapping description will be appropriately omitted for simplifying the description.

In the present example embodiment, it is assumed that target parts are a pupil center, an outer corner of an eye, and an inner corner of an eye. All of the target parts are areas included in an eye being a common part of a face.

Thus, a reference image according to the present example embodiment may be similar to that in the example embodiment 1, and is, for example, a right eye image. Further, each of an estimation target image and a target image according to the present example embodiment may also be similar to those in the example embodiment 1, and are, for example, a both eyes image.

Note that, in a case where a target part includes, at least one of a tip of a nose and the center of a nostril, each of a reference image, an estimation target image, and a target image includes a nose image. Further, for example, in a case where a target part is a corner of a mouth, each of a reference image, an estimation target image, and a target image includes a mouth image. In other words, a reference image, an estimation target image, and a target image may be prepared for each part (for example, a face part) including a target part.

The information processing apparatus 100 according to the present example embodiment may have a function substantially similar to that in the example embodiment 1. In other words, similarly to the example embodiment 1, a position estimation unit 110 according to the present example embodiment may extract a target part feature from a feature of an estimation target image, based on a learning result acquired by performing learning by using a reference image and a target image, and estimate a position of each target part in an estimation target, based on the target part feature.

However, in the present example embodiment, an outer corner of an eye and an inner corner of an eye are added to the target part in the example embodiment 1. Thus, in the present example embodiment, a variable (for example, a matrix) handled in each of an extraction unit 120 and an estimation unit 130 is extended in such a way as to add a component associated with the added target part.

In this way, a position of each target part in an estimation target can be estimated by using the extraction unit 120 and the estimation unit 130 having a function similar to that in the example embodiment 1. Furthermore, by performing processing (step S101, step S102, and step S110) similar to that in the example embodiment 1, a position of each target part in an estimation target can be estimated.

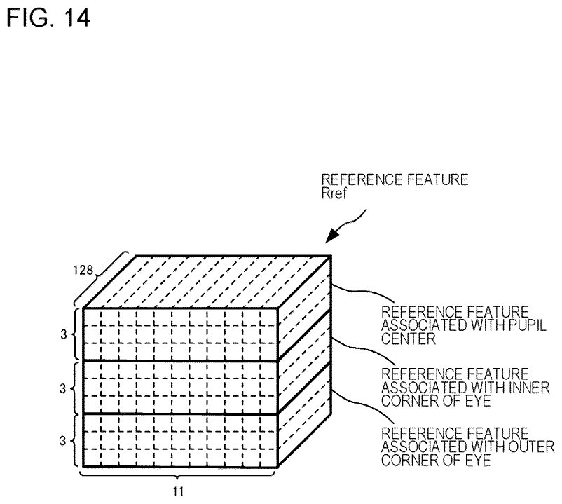

Specifically, for example, FIG. 14 is a schematic diagram illustrating one example of a data size and a data configuration of a reference feature Rref according to the present example embodiment. The reference feature Rref includes a portion (component) associated with each target part. A reference feature acquisition unit 122 may acquire the reference feature Rref as illustrated in FIG. 14 by using a feature extraction model with a basic image as an input. Note that, the data size and the data configuration of the reference feature Rref may be appropriately changed.

For example, a feature acquisition unit 121 may acquire a feature of an estimation target image including each portion of the feature of the estimation target image as a result of acquiring the feature of the estimation target image by using the feature extraction model with the estimation target image as an input. Each portion of the feature of the estimation target image may also have a data size and a data configuration similar to those of the reference feature Rref. In other words, for example, each Rsrch [i, j] includes a portion (component) associated with each of target parts (a pupil center, an inner corner of an eye, and an outer corner of an eye in the present example embodiment).

A generation unit 123 may generate similarity degree information including a matrix formed of a component for each target part. The similarity degree information includes a similarity degree map for each target part.

A feature extraction unit 124 may extract, according to a determination condition, a target part feature or each target part from the feature of the estimation target image, based on the similarity degree information.

For example, in a case where the determination condition according to the present example embodiment is similar to that in the example embodiment 1, the determination condition is a condition that a region has a maximum degree of similarity for each target part. In this case, the feature extraction unit 124 may determine a region associated with the maximum degree of similarity for each target part, based on the similarity degree information, and extract, from the feature of the estimation target image, a target part feature associated with each of the regions determined for each target part.

Then, the feature extraction unit 124 may extract a target part feature (matrix) associated with a whole of the plurality of target parts by integrating the extracted target part feature for each target part.

Similarly to the example embodiment 1, a region determination unit 131 may determine a region position for each target part, based on the similarity degree information and the target part feature or based on the determination condition and the similarity degree information. An output from the region determination unit 131 may be, for example, a value (matrix) including the region position for each target part as a component.

A first estimation unit 132 may estimate an in-region position for each target part by using a position estimation model with the target part feature as an input. Herein, for example, the position estimation model may be configured to output a value (matrix) including an in-region position for each target part in a component with, as an input, the target part feature associated with the whole of the plurality of target parts.

Similarly to the example embodiment 1, a second estimation unit 133 estimates a position of each target part of the estimation target in the entire region, based on the region position determined by the region determination unit 131 and the in-region position estimated by the first estimation unit 132. An output from the second estimation unit 133 may be, for example, a value (matrix) including the position for each target part as a component.

Similarly to the example embodiment 1, a conversion unit 134 may obtain a position for each target part by converting the position estimated by the second estimation unit 133.

Note that, an information processing apparatus 100 according to the present example embodiment may be configured physically similarly to that in the example embodiment 1.

The example embodiment 2 of the this disclosure is described above.

### Action and Effect

According to the present example embodiment, a plurality of target parts further include an outer corner of an eye and an inner corner of an eye.

In this way, a position of an outer corner of an eye and an inner corner of an eye can be accurately estimated.

### Example Embodiment 3

In the example embodiment 2, the example of extending a variable handled by each of the extraction unit 120 and the estimation unit 130 in order to estimate a position of each of a plurality of target parts is described. However, a method for estimating a position of each of a plurality of target parts is not limited to this. For example, an information processing apparatus may include a position estimation unit 110 for each target part. Further, for example, the information processing apparatus may include the position estimation unit 110 for each part (for example, a face part) including a target part. In the present example embodiment, an example in which the information processing apparatus includes the position estimation unit 110 for each target part will be described.

In the present example embodiment, a point different from the example embodiment 2 will be mainly described and overlapping description will be appropriately omitted for simplifying the description. In other words, similarly to the example embodiment 2, it is assumed that a target part according to the present example embodiment is a pupil center, an outer corner of an eye, and an inner corner of an eye.

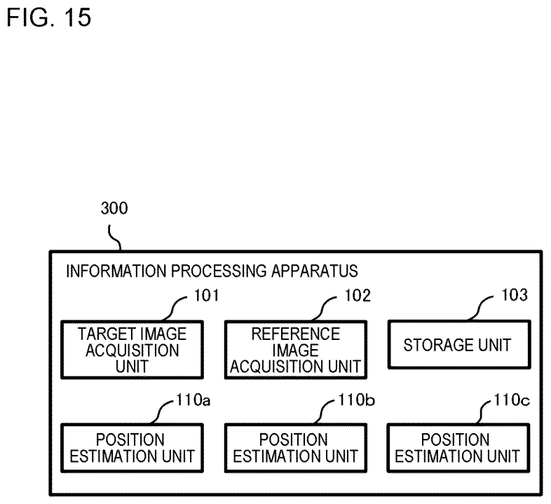

FIG. 15 is a diagram illustrating a functional configuration example of an information processing apparatus 300 according to the present example embodiment. The information processing apparatus 300 includes a target image acquisition unit 101, a reference image acquisition unit 102, and a storage unit 103 that are similar to those in the example embodiment 1, and a plurality of position estimation units 110a to 110c according to the number of target parts.

Each of the position estimation units 110a to 110c may be similar to that in the example embodiment 1 and has a function associated with each of target parts. For example, similarly to the example embodiment 1, the position estimation unit 110a has a function for estimating a position of a pupil center of an estimation target. The position estimation units 110b to 110c have a function for estimating a position of each of an outer corner of an eye and an inner corner of an eye of the estimation target.

Each of the position estimation units 110a to 110c may extract a target part feature from a feature of an estimation target image, based on a learning result acquired by performing learning by using a reference image and a target image, and estimate a position of a target part according to a function of the target part, based on the target part feature.

Each of the position estimation units 110 may use an estimation target image and a reference image according to an associated function. Further, each of a feature extraction model and a position estimation model may be prepared for each target part and stored in, for example, the storage unit 103.

The functional configuration example of the information processing apparatus 300 according to the present example embodiment is described above. The information processing apparatus 300 according to the present example embodiment may be configured physically similarly to the information processing apparatus 100 according to the example embodiment 1. Hereinafter, an operation example of the information processing apparatus 300 according to the present example embodiment will be described.

### (Operation Example of Information Processing Apparatus 300)

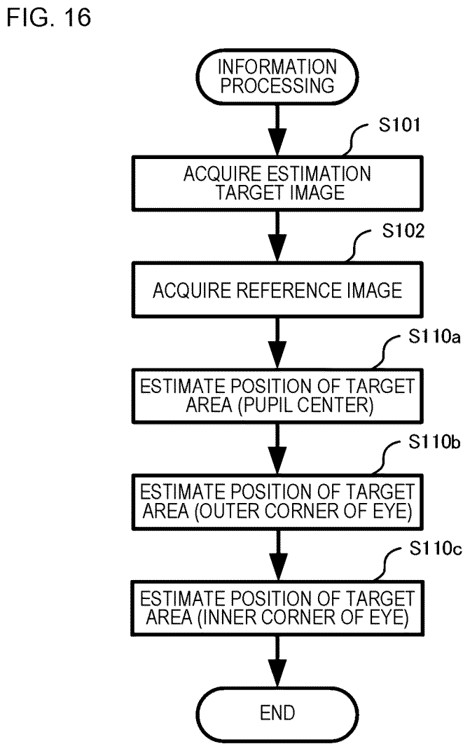

FIG. 16 is a flowchart illustrating one example of information processing according to the present example embodiment. The information processing according to the present example embodiment includes steps S101 and S102 similar to those in the information processing according to the example embodiment 1. Further, the information processing according to the present example embodiment includes position estimation processing (steps S110a to S110c) instead of the position estimation processing (step S110) according to the example embodiment 1.

The position estimation processing (steps S110a to S110c) is processing for estimating a position of each of a plurality of target parts. In other words, the position estimation unit 110a performs the position estimation processing (step S110a). The position estimation unit 110b performs the position estimation processing (step S110b). The position estimation unit 110c performs the position estimation processing (step S110c).

Each piece of the position estimation processing (steps S110a to S110c) may be substantially similar to the position estimation processing (step S110) according to the example embodiment 1.

In other words, the position estimation processing (step S110a) may be similar to the position estimation processing (step S110) according to the example embodiment 1. The position estimation processing (steps S110b) corresponds to processing in which a pupil center in the position estimation processing (step S110) according to the example embodiment 1 is replaced with an outer corner of an eye. The position estimation processing (steps S110c) corresponds to processing in which a pupil center in the position estimation processing (step S110) according to the example embodiment 1 is replaced with an inner corner of an eye.

The example embodiment 3 of the this disclosure is described above.

### Action and Effect

The present example embodiment can achieve an effect similar to the example embodiment 2.

### Modification Example 3

A plurality of target parts may be, for example, a pupil center of a right eye and a pupil center of a left eye. In this case, a reference image may include a right eye image and a left eye image. According to the present modification example, a position of a pupil center of each of a right eye and a left eye of an estimation target can be accurately estimated by using the information processing apparatus 300 according to the example embodiment 2 or 3.

### Example Embodiment 4

In the example embodiments 2 and 3, the example of estimating a position of a pupil center and another area of an eye is described. By using the example embodiments 2 and 3, a line-of-sight direction of an estimation target may be estimated. In the present example embodiment, a point different from the example embodiment 3 will be mainly described and overlapping description will be appropriately omitted for simplifying the description.

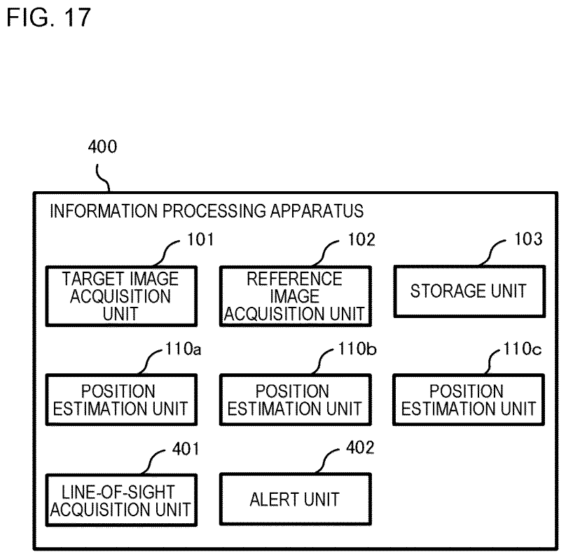

FIG. 17 is a diagram illustrating a functional configuration example of an information processing apparatus 400 according to the present example embodiment. The information processing apparatus 400 includes a target image acquisition unit 101, a reference image acquisition unit 102, a storage unit 103, and a plurality of position estimation units 110a to 110c that are similar to those in the example embodiment 2. In addition to these, the information processing apparatus 400 includes a line-of-sight acquisition unit 401 and an alert unit 402.

The line-of-sight acquisition unit 401 estimates a line-of-sight direction of a person being an estimation target, based on positions of a pupil center, an outer corner of an eye, and an inner corner of an eye being estimated by each of the position estimation units 110a to 110c.

Note that, a position of a predetermined area used for estimating a line-of-sight direction is not limited to positions of a pupil center, an outer corner of an eye, and an inner corner of an eye, and may be positions of a plurality of target parts. Such plurality of target parts are, for example, an area included in an eye, and may be one or a plurality of a pupil center, an outer corner of an eye, an inner corner of an eye, (an upper end of) an upper eyelid, and (an upper end of) a lower eyelid.

The alert unit 402 outputs an alert in a case where the line-of-sight direction of the estimation target being estimated by the line-of-sight acquisition unit 401 satisfies a predetermined alert condition.

The functional configuration example of the information processing apparatus 400 according to the present example embodiment is described above. The information processing apparatus 400 according to the present example embodiment may be configured physically similarly to the information processing apparatus 100 according to the example embodiment 1. Hereinafter, an operation example of the information processing apparatus 400 according to the present example embodiment will be described.

### (Operation Example of Information Processing Apparatus 400)

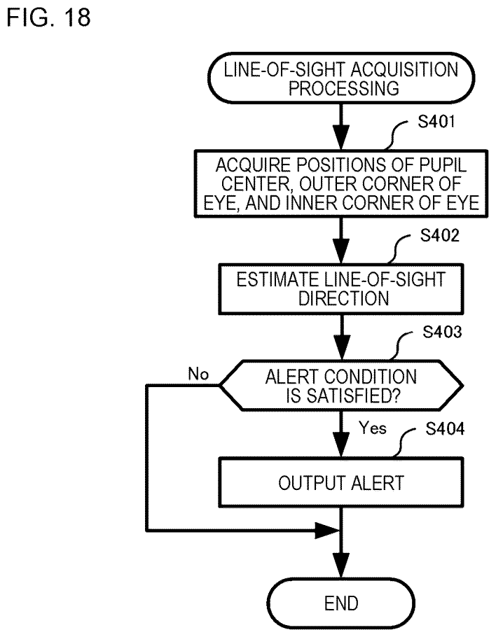

FIG. 18 is a flowchart illustrating one example of line-of-sight acquisition processing according to the present example embodiment. The line-of-sight acquisition processing is processing for estimating a line-of-sight direction of an estimation target. The line-of-sight acquisition processing may be performed subsequently to, for example, the information processing according to the example embodiment 3. In other words, for example, the line-of-sight acquisition processing starts in response to, as a trigger, positions of a pupil center, an outer corner of an eye, and an inner corner of an eye of an estimation target being estimated as a result of performing the information processing.

The line-of-sight acquisition unit 401 acquires positions of a pupil center, an outer corner of an eye, and an inner corner of an eye of an estimation target being estimated by performing the information processing (step S401).

Specifically, for example, the line-of-sight acquisition unit 401 acquires positions of a pupil center, an outer corner of an eye, and an inner corner of an eye of an estimation target from each of the plurality of position estimation units 110a to 110.

The line-of-sight acquisition unit 401 estimates a line-of-sight direction of a person being the estimation target, based on the positions of the pupil center, the outer corner of the eye, and the inner corner of the eye acquired in step S401 (step S402).

Specifically, for example, the line-of-sight acquisition unit 401 estimates a line-of-sight direction of the estimation target by using a line-of-sight estimation model with, as an input, the positions of the pupil center, the outer corner of the eye, and the inner corner of the eye of the estimation target. The line-of-sight direction is, for example, a direction in an estimation target image, and a direction in a real space associated with the estimation target image.

The line-of-sight estimation model is a model for estimating a line-of-sight direction of an estimation target, and is a trained model subjected to machine learning with, as an input, positions of a pupil center, an outer corner of an eye, and an inner corner of an eye. Input data to a learning model during learning include positions of a pupil center, an outer corner of an eye, and an inner corner of an eye. In the machine learning, for example, supervised learning using correct data including a line-of-sight direction according to the positions of the pupil center, the outer corner of the eye, and the inner corner of the eye included in the input data may be performed.

The alert unit 402 decides whether a predetermined alert condition is satisfied (step S403). Examples of the alert condition will be described below.

In a case where it is decided that the alert condition is not satisfied (step S403; No), the alert unit 402 ends the line-of-sight acquisition processing. In a case where it is decided that the alert condition is satisfied (step S403; Yes), the alert unit 402 outputs an alert (step S404), and ends the line-of-sight acquisition processing.

### Example 1 of Alert Condition and Alert

In a case where the information processing apparatus 400 is mounted on an authentication apparatus for performing biometric authentication (for example, iris authentication, face authentication) of an estimation target, the line-of-sight acquisition unit 401 may set a person being an authentication target as an estimation target, and estimate a line-of-sight direction of the estimation target. It is assumed that the authentication apparatus includes a camera for capturing a person being an authentication target.

In this case, the alert condition may be a condition that a line-of-sight direction of the person being the authentication target is directed to a direction different from a lens of the camera. The alert unit 402 may output an alert in a case where the estimated line-of-sight direction of the estimation target is directed to a direction different from the lens of the camera.

The alert is, for example, information that prompts an authentication target to be directed to a direction of the camera. For example, the alert may be output by sound, may be a character, a figure, and the like displayed on a display unit of the authentication apparatus, and may be light emission from a lamp disposed in association with the camera.

In this way, at a time at which biometric authentication of an authentication target is performed, a possibility that a captured image suitable for authentication can be acquired can be improved. Therefore, an improvement in accuracy of authentication can be achieved.

### Example 2 of Alert Condition and Alert

In a case where the information processing apparatus 400 is mounted on a camera, the line-of-sight acquisition unit 401 may set a person being a subject as an estimation target, and estimate a line-of-sight direction of the estimation target. In this case, the alert condition may be a condition that a line-of-sight direction of the subject is directed to a direction different from a lens of the camera. The alert unit 402 may output an alert in a case where the estimated line-of-sight direction of the estimation target is directed to a direction different from the lens of the camera.

The alert is, for example, a mark overlapping and being displayed on a captured image displayed on a display unit of the camera. The mark is, for example, a frame displayed in a predetermined color such as red and black and a predetermined manner (for example, blinking, continuous display, and the like), and is disposed in such a way that a subject having a line-of-sight direction being directed to a direction different from the lens of the camera can be determined by surrounding the subject, and the like.

In this way, at a time at which capturing such as a group photograph is performed, a person who performs capturing can easily know a subject having a line-of-sight direction being directed to a direction different from a lens of a camera. Then, the person who performs capturing can prompt the subject to direct a line of sight to the camera.

### Example 3 of Alert Condition and Alert

The information processing apparatus 400 may set a pedestrian and the like as an estimation target and estimate a line-of-sight direction of the estimation target, based on a captured image from a surveillance camera. In this case, the alert condition may be a condition that the estimation target is looking at a security guard, a condition that the estimation target is looking at a security guard with a predetermined frequency or higher, or the like. The alert unit 402 may output the alert in a case where the alert unit 402 detects an estimation target that satisfies the alert condition. An output destination of the alert unit 402 may be, for example, a terminal apparatus (for example, a smartphone, a tablet terminal, and the like) possessed by the security guard, an apparatus provided at a security center, and the like.

In this way, a suspicious person can be detected at an early stage. In this way, the suspicious person can be quickly handled, and thus safety can be improved.

The example embodiment 4 of the this disclosure is described above.

### Action and Effect

According to the present example embodiment, a target part is plural. The information processing apparatus 400 further includes the line-of-sight acquisition unit 401 that estimates a line-of-sight direction of a person being an estimation target, based on a position of each of a plurality of target parts.

Positions of a plurality of target parts can be accurately estimated, and thus a line-of-sight direction can be estimated. A line-of-sight direction can be used for various purposes, and thus convenience can be improved.

According to the present example embodiment, the information processing apparatus 400 further includes the alert unit 402 that outputs an alert related to an estimation target, based on a line-of-sight direction.

By outputting the alert, information based on a line-of-sight direction of an estimation target can be notified to a person other than the estimation target. In this way, as described above, a captured image suitable for authentication can be acquired, and the like. Therefore, convenience can be improved.

### Example Embodiment 5

In the present example embodiment, an example in which an information processing apparatus has a learning function of the learning model (the feature extraction model and the position estimation model) described in the example embodiment 1. Note that, the learning function may be included in another apparatus different from the information processing apparatus, and a learning result of the learning function may be used in the information processing apparatus 100.

In the present example embodiment, a point different from the example embodiment 1 will be mainly described and overlapping description will be appropriately omitted for simplifying the description.

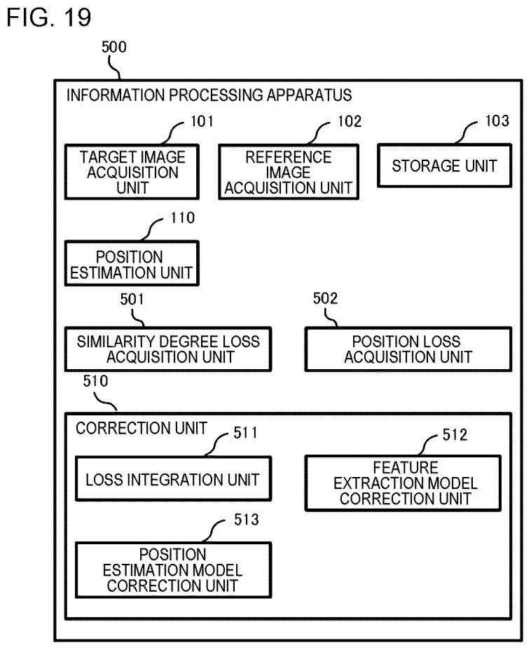

FIG. 19 is a diagram illustrating a functional configuration example of an information processing apparatus 500 according to the present example embodiment. The information processing apparatus 500 includes a target image acquisition unit 101, a reference image acquisition unit 102, a storage unit 103, and a position estimation unit 110 that are similar to those in the example embodiment 1. In addition to these, the information processing apparatus 500 includes a similarity degree loss acquisition unit 501, a position loss acquisition unit 502, and a correction unit 510.

The similarity degree loss acquisition unit 501 obtains a similarity degree loss, based on similarity degree information and a similarity degree loss function L.

The similarity degree loss function L is a function for obtaining a similarity degree loss. A similarity degree loss is a loss related to the similarity degree information.

The position loss acquisition unit 502 obtains a position loss, based on a position loss function M.

The position loss function M is a function for obtaining a position loss. The position loss is a loss related to an in-region position estimated by using the position estimation model with, as an input, a target part feature of a feature of a target image.

The correction unit 510 corrects the feature extraction model and the position estimation model, based on the similarity degree loss and the position loss. Note that, the correction unit 510 may correct only one of the feature extraction model and the position estimation model. As a result of a correction or an improvement by the correction unit 510, the correction unit 510 corrects at least one of the feature extraction model and the position estimation model. Therefore, the correction unit 510 may be referred to as an improvement unit, an optimization unit, and the like.

Specifically, for example, as illustrated in FIG. 19, the correction unit 510 includes a loss integration unit 511, a feature extraction model correction unit 512, and a position estimation model correction unit 513.

The loss integration unit 511 obtains an integrated loss acquired by integrating the similarity degree loss obtained by the similarity degree loss acquisition unit 501 and the position loss obtained by the position loss acquisition unit 502.

The feature extraction model correction unit 512 corrects the feature extraction model, based on the integrated loss obtained by the loss integration unit 511.

The position estimation model correction unit 513 corrects the position estimation model, based on the integrated loss obtained by the loss integration unit 511.

The functional configuration example of the information processing apparatus 500 according to the present example embodiment is described above. The information processing apparatus 500 according to the present example embodiment may be configured physically similarly to the information processing apparatus 100 according to the example embodiment 1. Hereinafter, an operation example of the information processing apparatus 500 according to the present example embodiment will be described.

### (Operation Example of Information Processing Apparatus 500)

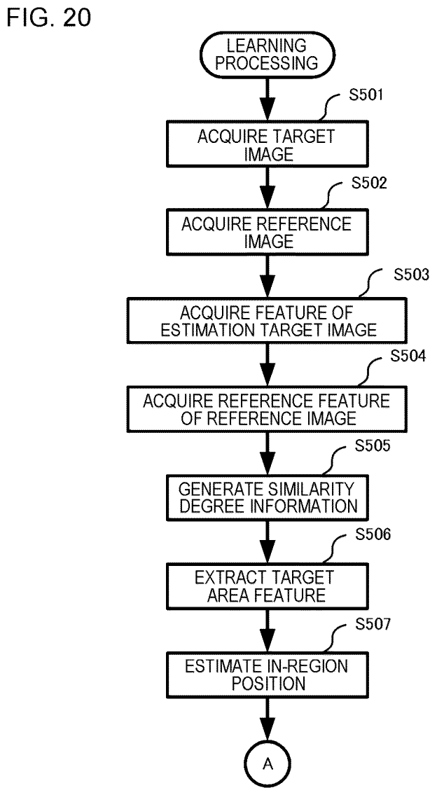

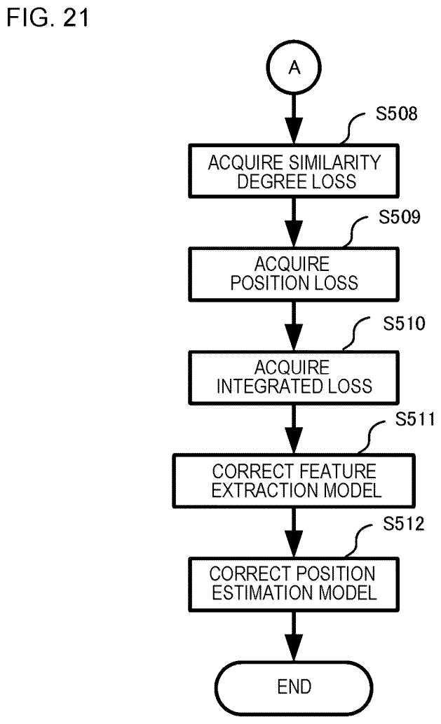

FIGS. 20 and 21 are flowcharts illustrating one example of learning processing according to the present example embodiment. The learning processing is processing for machine learning of the feature extraction model and the position estimation model.

For example, the learning processing starts in response to, as a trigger, reception of a start instruction from a user. Subsequently, for example, the learning processing may be repeatedly performed until an end condition is satisfied. The end condition may be, for example, a repeated number, and may be a condition that a similarity degree loss, a position loss, and an integrated loss are equal to or less than a predetermined threshold value, and the like.

The information processing apparatus 500 performs steps S501 to S506 being processing associated with steps S101 to S102, S111 to S114, and S132 according to the example embodiment 1.

Specifically, the target image acquisition unit 101 acquires a target image (step S501).

In other words, in the present example embodiment, the target image acquisition unit 101 acquires a target image instead of an estimation target image in S101 according to the example embodiment 1. As described in the example embodiment 1, the target image is, for example, a both eyes image.

Similarly to step S102 according to the example embodiment 1, the reference image acquisition unit 102 acquires a reference image (step S502). The reference image acquired herein may be the same as a reference image acquired in step S102 according to the example embodiment 1.

The feature acquisition unit 121 acquires a feature of the target image by using the feature extraction model with the target image acquired in step S501 as an input (step S503).

In other words, in the present example embodiment, the feature acquisition unit 121 acquires a feature of the target image instead of a feature of an estimation target image in S111 according to the example embodiment 1.

More specifically, in step S503, the feature acquisition unit 121 acquires a feature of the target image, based on an input different from that in S111 according to the example embodiment 1. Further, step S503 is also different from S111 according to the example embodiment 1 in a point that the feature extraction model used in step S503 is a model during learning. Except for the points, the processing in step S503 may be similar to the processing in step S111 according to the example embodiment 1.

The reference feature acquisition unit 122 acquires a reference feature by using the feature extraction model similarly to step S112 according to the example embodiment 1 with the reference image acquired in step S502 as an input (step S504).

More specifically, step S504 is different from S112 according to the example embodiment 1 in a point that the feature extraction model used in step S504 is a model during learning. Except for the point, the processing in step S504 may be similar to the processing in step S112 according to the example embodiment 1. In other words, for example, the reference image used for the input in step S502 may be the same as a reference image used for an input in step S112 according to the example embodiment 1.

The generation unit 123 generates similarity degree information similarly to step S113 according to the example embodiment 1, based on the feature of the target image and the reference feature respectively acquired in steps S503 and S504 (step S505).

More specifically, in step S505, the generation unit 123 generates similarity degree information, based on an input different from that in S113 according to the example embodiment 1. In other words, except for the point of the different inputs, the processing in step S505 may be similar to the processing in step S113 according to the example embodiment 1.

The feature extraction unit 124 extracts a target part feature from the feature of the target image similarly to step S114 according to the example embodiment 1, based on the similarity degree information generated in step S505 (step S506).

More specifically, in step S506, the feature extraction unit 124 extracts a target part feature, based on an input different from that in step S114 according to the example embodiment 1. In other words, except for the point of the different inputs, the processing in step S506 may be similar to the processing in step S114 according to the example embodiment 1.

The first estimation unit 132 estimates an in-region position by using the position estimation model with, as an input, the target part feature extracted in step S506 (step S507).

More specifically, in step S507, the first estimation unit 132 estimates an in-region position, based on an input different from that in S132 according to the example embodiment 1. Further, step S507 is also different from S132 according to the example embodiment 1 in a point that the position estimation model used in step S507 is a model during learning. Except for the points, the processing in step S507 may be similar to the processing in step S132 according to the example embodiment 1.

FIG. 21 is referred.

The similarity degree loss acquisition unit 501 obtains a similarity degree loss, based on the similarity degree information and the similarity degree loss function L (step S508).

Specifically, for example, the similarity degree loss function L is, for example, a function that obtains a difference between a correct map being input as correct data and a degree of similarity included in the similarity degree information generated in step S505.

The correct map may be, for example, a two-dimensional map in which only a position of an eye is provided with a label “1” and the other position is provided with a label “0”.

The similarity degree loss function L may be, for example, a function that acquires a probability by multiplying a degree of similarity included in the similarity degree information by a softmax function in a map direction, and obtains a cross entropy with a correction map y. Further, the similarity degree loss function L may use CosFace and the like in order to emphasize similarity. Specifically, for example, as indicated in Equation (2), at a time at which a binary cross entropy error (BCE) with the correct map y is obtained, hyper parameters s, m for correction may be applied. Equation (2) is one example of the similarity degree loss function L.

$$\begin{matrix}[ Mathematical 2 ] & \\ L = - \frac{1}{\vert U \vert} {\sum }_{u ∈ U} \{ ( 1 - y [ u ] ) log \frac{{e}^{s cos {θ}_{u}}}{{\sum }_{i ∈ U , t \neq u} {e}^{s cos {θ}_{i}} + {e}^{s ( cos {θ}_{u} - m )}} + y [ u ] log \frac{{e}^{s ( cos {θ}_{u} - m )}}{{\sum }_{i ∈ U , t \neq u} {e}^{s cos {θ}_{i}} + {e}^{s ( cos {θ}_{u} - m )}} \} & ( 2 )\end{matrix}$$

The position loss acquisition unit 502 obtains a position loss, based on the position estimated in step S507 and the position loss function M (step S509).

Specifically, for example, the position loss function M may be an absolute value error, a square error, and the like as indicated in Equation (3). Equation (3) is one example of the position loss function M. In Equation (3), (X, Y) represents the position estimated in step S507. (Xg, Yg) represents a correct position.

$$\begin{matrix}[ Mathematical 3 ] & \\ M = β \cdot \frac{β ( \vert X - Xg \vert + \vert Y - Yg \vert )}{2} & ( 3 )\end{matrix}$$

The loss integration unit 511 obtains an integrated loss S acquired by integrating the similarity degree loss obtained in step S508 and the position loss obtained in step S509 (step S510).

Specifically, for example, the loss integration unit 511 obtains the integrated loss S (=a value acquired by using the similarity degree loss function L+a value acquired by using the position loss function M) by adding the similarity degree loss and the position loss.

The feature extraction model correction unit 512 corrects the feature extraction model, based on the integrated loss S obtained in step S510 (step S511).

Specifically, for example, the feature extraction model correction unit 512 corrects the feature extraction model by updating a parameter included the feature extraction model in such a way as to reduce the integrated loss S.

The position estimation model correction unit 513 corrects the position estimation model, based on the integrated loss S obtained in step S510 (step S512), and ends the learning processing.

Specifically, for example, the position estimation model correction unit 513 corrects the position estimation model by updating a parameter included the position estimation model in such a way as to reduce the integrated loss S.

By performing such learning processing, a parameter included in the feature extraction model and the position estimation model can be corrected.

The example embodiment 5 of the this disclosure is described above.

### Action and Effect

According to the present example embodiment, the information processing apparatus 500 further includes the position loss acquisition unit 502 and the correction unit 510. The position loss acquisition unit 502 obtains a position loss being a loss related to an in-region position estimated by using the position estimation model with a target part feature of a feature of a target image as an input, based on the position loss function M. The correction unit 510 corrects the position estimation model, based on the position loss.

In this way, estimation accuracy by using the position estimation model can be improved. Therefore, a position of a target part can be more accurately estimated.

According to the present example embodiment, a learning result includes a learned feature extraction model subjected to machine learning for extracting a feature of an estimation target image. The information processing apparatus 500 further includes the similarity degree loss acquisition unit 501 that obtains a similarity degree loss being a loss related to similarity degree information, based on the similarity degree information and a similarity degree loss function. The correction unit 510 further corrects the feature extraction model, based on the similarity degree loss.

In this way, a more appropriate feature can be acquired by using the feature extraction model, and a position of a target part can be estimated. Therefore, a position of a target part can be more accurately estimated.

According to the present example embodiment, the correction unit 510 includes the loss integration unit 511, the feature extraction model correction unit 512, and the position estimation model correction unit 513. The loss integration unit 511 obtains an integrated loss acquired by integrating a position loss and a similarity degree loss. The feature extraction model correction unit 512 corrects the position estimation model, based on the integrated loss. The position estimation model correction unit 513 corrects the feature extraction model, based on the integrated loss.

In this way, a more appropriate feature can be acquired by using the feature extraction model, and estimation accuracy using the position estimation model can be improved. Therefore, a position of a target part can be still further accurately estimated.

Further, both models of the feature extraction model and the position estimation model can be corrected as a whole by using an integrated loss in such a way as to improve estimation accuracy. Therefore, a position of a target part can be still further accurately estimated.

### Example Embodiment 6

There is a risk that a position loss is included in the position loss function M according to the example embodiment 5 even in a case where a target part feature extracted by the position estimation unit 110 is associated with a region that does not include a target part (for example, a pupil center).

A position loss function M according to the present example embodiment is a function that does not include, in a position loss, a loss related to a position estimated by using a position estimation model with, as an input, a target part feature input to the position estimation model in a case where the target part feature is different from a portion associated with a target part.

Equation (4) is one example of the position loss function M according to the present example embodiment. The position loss function M according to the present example embodiment is acquired by adding a mask a to the position loss function M according to the example embodiment 5. α is 1 in a case where |X−Xg|<2 is satisfied, and α is 0 in the other case.

$$\begin{matrix}[ Mathematical 4 ] & \\ M = α * β \cdot \frac{β ( \vert X - Xg \vert + \vert Y - Yg \vert )}{2} & ( 4 )\end{matrix}$$

The example embodiment 6 of the this disclosure is described above.

### Action and Effect

According to the present example embodiment, the position loss function M is a function that does not include, in a position loss, a loss related to a position estimated by using the position estimation model with, as an input, a target part feature input to the position estimation model in a case where the target part feature is different from a portion associated with a target part.

In this way, in a case where a target part feature different from a portion associated with a target part is extracted, a possibility that a loss related to an estimation result based on the target part feature is included in a position loss can be reduced. In other words, learning based on a target part feature associated with a region greatly shifted from a target part or a vicinity thereof can be at least reduced. Therefore, a position of a target part can be still further accurately estimated.

### Example Embodiment 7

In the example embodiment 5, the example of integrating a similarity degree loss and a position loss is described, but a similarity degree loss and a position loss may not be integrated.

In the present example embodiment, a correction unit 510 may not include a loss integration unit 511.

A feature extraction model correction unit 512 may correct a feature extraction model, based on a similarity degree loss obtained by a similarity degree loss acquisition unit 501. Specifically, for example, the feature extraction model correction unit 512 may correct the feature extraction model by updating a parameter included the feature extraction model in such a way as to reduce the similarity degree loss.

A position estimation model correction unit 513 may correct a position estimation model, based on a position loss obtained by a position loss acquisition unit 502. Specifically, for example, the position estimation model correction unit 513 may correct the position estimation model by updating a parameter included the position estimation model in such a way as to reduce the position loss.

Except for the points, an information processing apparatus according to the present example embodiment may be configured similarly to the information processing apparatus 500 according to the example embodiment 5. The information processing apparatus according to the present example embodiment may be configured physically similarly to the information processing apparatus 100 according to the example embodiment 1.

In learning processing according to the present example embodiment, step S510 may not be performed.

In step S511, the feature extraction model correction unit 512 may correct the feature extraction model, based on a similarity degree loss obtained in step S508. In step S512, the position estimation model correction unit 513 may correct the position estimation model, based on a position loss obtained in step S509.

Except for the points, the learning processing according to the present example embodiment may be similar to the learning processing according to the example embodiment 5.

The example embodiment 7 of the this disclosure is described above.

### Action and Effect

According to the present example embodiment, each of the feature extraction model and the position estimation model can also be corrected. Therefore, a position of a target part can be accurately estimated.

### Example Embodiment 8

In the present example embodiment, an example in which an estimated position of a target part is displayed on a display unit will be described. In the present example embodiment, a point different from the example embodiment 4 will be mainly described and overlapping description will be appropriately omitted for simplifying the description.

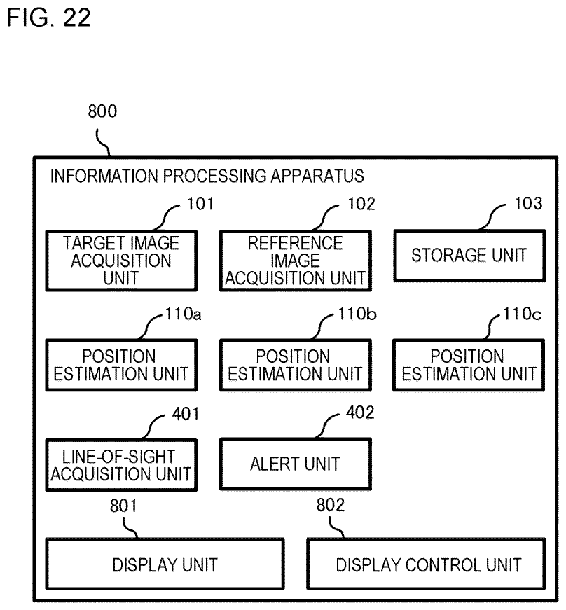

FIG. 22 is a diagram illustrating a functional configuration example of an information processing apparatus 800 according to the present example embodiment. The information processing apparatus 800 includes a target image acquisition unit 101, a reference image acquisition unit 102, a storage unit 103, a plurality of position estimation units 110a to 110c, a line-of-sight acquisition unit 401, and an alert unit 402 that are similar to those in the example embodiment 4. In addition to these, the information processing apparatus 800 includes a display unit 801 and a display control unit 802.

The display unit 801 displays various types of information. The display unit 801 is formed of, for example, a liquid crystal panel, an organic EL, and the like. The display control unit 802 controls the display unit 801, and displays various types of information on the display unit 801.

Specifically, for example, the display control unit 802 may display, on the display unit 801, a region position determined by a region determination unit 131 and a position of a target part of an estimation target estimated by a position estimation unit 110 over an estimation target image in an overlapping manner. At this time, the display control unit 802 may correct the region position determined by the region determination unit 131 to be a position in the estimation target image.

Further, for example, the display control unit 802 may display, on the display unit 801, a position of a target part in an estimation target in a more emphasized manner than an associated region.

Furthermore, for example, the display control unit 802 may display, on the display unit 801, a line-of-sight direction of an estimation target estimated by a line-of-sight acquisition unit 401 over an estimation target image in an overlapping manner.

The functional configuration example of the information processing apparatus 800 according to the present example embodiment is described above. The information processing apparatus 800 according to the present example embodiment may be configured physically similarly to the information processing apparatus 100 according to the example embodiment 1. Hereinafter, an operation example of the information processing apparatus 800 according to the present example embodiment will be described.

### (Operation Example of Information Processing Apparatus 800)

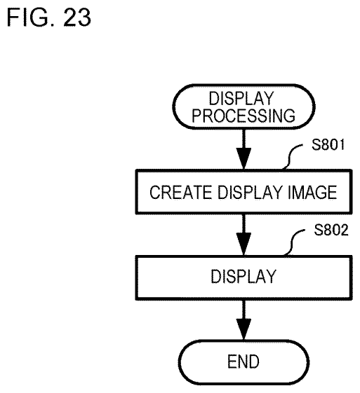

FIG. 23 is a flowchart illustrating one example of display processing according to the present example embodiment. The display processing is processing for displaying an estimated result on the display unit 801. The display processing may be performed subsequently to, for example, the line-of-sight acquisition processing according to the example embodiment 4. In other words, for example, the display processing starts in response to, as a trigger, a line-of-sight direction being estimated as a result of performing the line-of-sight acquisition processing. Note that, in a case where a line-of-sight direction is set not to be displayed, the display processing may be performed subsequently to the information processing.

The display control unit 802 creates a display image (step S801).

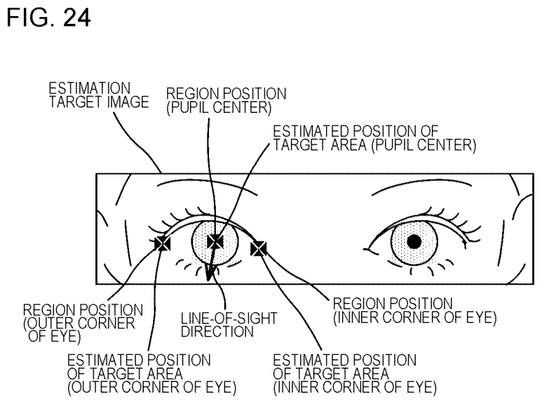

FIG. 24 is a diagram illustrating one example of a display image according to the present example embodiment. The display image in the example illustrated in FIG. 24 includes a region position determined by the region determination unit 131 and a position of a target part of an estimation target estimated by the position estimation unit 110 over an estimation target image in an overlapping manner.

A region position in the example illustrated in FIG. 24 is indicated by a rectangle (black square in FIG. 24) according to a shape of an estimated associated region. The region position may be indicated by an appropriate color such as red and blue, for example. Further, the region position may be indicated by a light color and the like, and is thus easily compared with an image of an estimation target included in an estimation target image.

A position of a target part in the example illustrated in FIG. 24 is indicated by X. Note that, a method for indicating a position of a target part is not limited to this, and the position may be indicated by using an appropriate mark and the like.

A position of a target part in the example illustrated in FIG. 24 is printed in white and is thus included in a more emphasized manner than the region position. Note that, a manner for emphasis is not limited to this, and may be a color in appropriate depth, a mark, and the like.

The display image in the example illustrated in FIG. 24 further includes an arrow indicating a line-of-sight direction estimated by the line-of-sight acquisition unit 401 over the estimation target image in an overlapping manner.

FIG. 23 is referred again.

The display control unit 802 displays the display image created in step S801 on the display unit 801 (step S802), and ends the display processing. In this way, the associated region, the estimated position of the target part, and the line-of-sight direction can be displayed over the estimation target image in an overlapping manner on the display unit 801.

The example embodiment 8 of the this disclosure is described above.

### Action and Effect

According to the present example embodiment, the information processing apparatus 800 further includes the display control unit 802 that displays, on the display unit 801, a position of a target part in an estimation target and an associated region over an estimation target image in an overlapping manner.

In this way, a position (i.e., a position of a target part in an estimation target and an associated region) estimated by a different technique can overlap an estimation target image for comparison. Therefore, a user can easily recognize accuracy of estimation, and thus convenience can be improved.

### Action and Effect

According to the present example embodiment, the display control unit 802 displays, on the display unit 801, a position of a target part in an estimation target in a more emphasized manner than an associated region.

In this way, a user can easily visually recognize a position estimated with a higher degree of reliability than an associated region. Therefore, convenience can be improved.

### Example Embodiment 9

In the present example embodiment, a configuration example of an information processing system including an information processing apparatus will be described. The information processing apparatus may be any in the other example embodiments, but description is given in the present example embodiment with the information processing apparatus 100 according to the example embodiment 1 as an example.

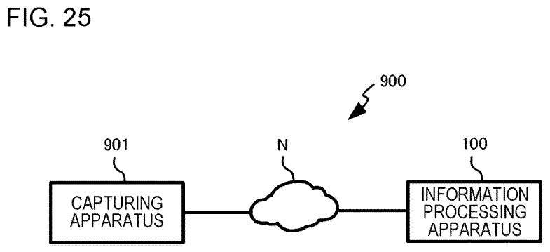

FIG. 25 is a diagram illustrating a configuration example of an information processing system 900 according to the present example embodiment. The information processing system 900 includes a capturing apparatus 901 and an information processing apparatus 100 similar to that in the example embodiment 1.

The capturing apparatus 901 captures an estimation target. The capturing apparatus 901 and the information processing apparatus 100 are connected to each other via a communication network N constituted in a wired manner, a wireless manner, or a combination of the manners. In this way, the capturing apparatus 901 and the information processing apparatus 100 can transmit and receive information to and from each other.

For example, the information processing apparatus 100 acquires an image in which an estimation target is captured from the capturing apparatus 901 via the communication network N.

The example embodiment 9 of the this disclosure is described above.

### Action and Effect

The present example embodiment can achieve an effect similar to the example embodiment 1.

### Modification Example 4

The information processing system 900 may include a plurality of the capturing apparatuses 901. The plurality of capturing apparatuses 901 may include, for example, a first capturing apparatus for capturing a whole body of an estimation target, and a second capturing apparatus for capturing an estimation target image (both eyes image).

Further, for example, the second capturing apparatus for capturing an estimation target image may be plural. In this case, the second capturing apparatuses may be provided at different heights. A control apparatus that controls the plurality of capturing apparatuses 901 may estimate a height of both eyes of an estimation target, based on a whole body image captured by the first capturing apparatus. Then, the control apparatus may control the plurality of second capturing apparatuses in such a way that the both eyes of the estimation target are captured by using the second capturing apparatus installed in a position according to the estimated height of the both eyes,

The present example embodiment can achieve an effect similar to the example embodiment 1.

While the example embodiments and the modification examples have been described with reference to the drawings in this disclosure, the example embodiments and the modification examples are only exemplification, and various configurations other than the above-described example embodiments and modification examples can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, the example embodiments and the modification examples described above can be combined within an extent that a content is not inconsistent.

A part or the whole of the above-described example embodiment may also be described in supplementary notes below, which is not limited thereto.
1. An information processing apparatus including:
   a target image acquisition unit that acquires an estimation target image including an image of a target part in an estimation target; and
   a position estimation unit that extracts a target part feature related to a portion associated with the target part from a feature of the estimation target image, based on a learning result acquired by performing learning by using a reference image including an image of a target part and a target image including an image of the target part, and estimates a position of the target part, based on the target part feature.
2. The information processing apparatus according to supplementary note 1, wherein
   the position estimation unit includes an extraction unit that generates similarity degree information indicating a degree of similarity between a feature of the estimation target image and a reference feature being a feature of the reference image, and extracts the target part feature from a feature of the estimation target image, based on the similarity degree information.
3. The information processing apparatus according to supplementary note 2, wherein
   the extraction unit includes
      a generation unit that generates the similarity degree information, based on a feature of the estimation target image and the reference feature, and
      a feature extraction unit that extracts the target part feature from a feature of the estimation target image, based on the similarity degree information.
4. The information processing apparatus according to supplementary note 3, wherein
   the learning result includes a learned feature extraction model subjected to machine learning for extracting a feature of the estimation target image, and
   the extraction unit further includes a feature acquisition unit that acquires a feature of the estimation target image by using the feature extraction model with the estimation target image as an input.
5. The information processing apparatus according to any one of supplementary notes 2 to 4, wherein
   the learning result includes a learned position estimation model subjected to machine learning for estimating an in-region position indicating a position of the target part in an associated region being associated with the target part feature, and
   the position estimation unit includes an estimation unit that estimates the in-region position by using the position estimation model with the target part feature as an input, and estimates a position of the target part, based on the in-region position.
6. The information processing apparatus according to supplementary note 5, wherein
   the estimation unit includes
      a region determination unit that determines a region position indicating a position of the associated region,
      a first estimation unit that estimates the in-region position by using the position estimation model with the target part feature as an input, and
      a second estimation unit that estimates a position of the target part, based on the region position and the in-region position.
7. The information processing apparatus according to supplementary note 6, wherein
   the estimation unit further includes a conversion unit that converts the estimated position of the target part into a position in the estimation target image.
8. The information processing apparatus according to any one of supplementary notes 5 to 7, further including:
   a position loss acquisition unit that obtains a position loss being a loss related to the in-region position estimated by using the position estimation model with the target part feature of a feature of the target image as an input, based on a position loss function; and
   a correction unit that corrects the position estimation model, based on the position loss.
9. The information processing apparatus according to supplementary note 8, wherein
   the position loss function is a function that does not include, in the position loss, a loss related to a position estimated by using the position estimation model with, as an input, the target part feature input to the position estimation model in a case where the target part feature is different from a portion associated with the target part.
10. The information processing apparatus according to supplementary note 8 or 9, wherein
   the learning result includes a learned feature extraction model subjected to machine learning for extracting a feature of the estimation target image,
   the information processing apparatus further includes a similarity degree loss acquisition unit that obtains a similarity degree loss being a loss related to the similarity degree information, based on the similarity degree information and a similarity degree loss function, and
   the correction unit further corrects the feature extraction model, based on the similarity degree loss.
11. The information processing apparatus according to supplementary note 10, wherein
   the correction unit includes
      a loss integration unit that obtains an integrated loss acquired by integrating the position loss and the similarity degree loss,
      a feature extraction model correction unit that corrects the feature extraction model, based on the integrated loss, and
      a position estimation model correction unit that corrects the position estimation model, based on the integrated loss.
12. The information processing apparatus according to any one of supplementary notes 5 to 11, further including
   a display control unit that displays, on a display unit, a position of the target part in the estimation target and the associated region over the estimation target image in an overlapping manner.
13. The information processing apparatus according to supplementary note 12, wherein
   the display control unit displays, on the display unit, a position of the target part in the estimation target in a more emphasized manner than the associated region.
14. The information processing apparatus according to any one of supplementary notes 2 to 13, wherein
   the estimation target is a person,
   the target part is a pupil center,
   the reference image is a one eye image including only a predetermined eye,
   the target image is a both eyes image including both eyes, and
   the degree of similarity is a spatial cosine degree of similarity.
15. The information processing apparatus according to supplementary note 14, wherein
   the target part is plural, and
   the information processing apparatus further includes a line-of-sight acquisition unit that estimates a line-of-sight direction of a person being the estimation target, based on a position of each of the plurality of target parts.
16. The information processing apparatus according to supplementary note 15, wherein
   the plurality of target parts further include an outer corner of an eye and an inner corner of an eye.
17. The information processing apparatus according to supplementary note 15 or 16, further including
   an alert unit that outputs an alert related to the estimation target, based on the line-of-sight direction.
18. The information processing apparatus according to any one of supplementary notes 1 to 17, wherein
   the target part includes at least one of a pupil center, an outer corner of an eye, and an inner corner of an eye.
19. An information processing system including:
   the information processing apparatus according to any one of supplementary notes 1 to 18; and
   a capturing apparatus for capturing the estimation target.
20. An information processing method including,
   by one or more computers:
   acquiring an estimation target image including an image of a target part in an estimation target; and
   extracting a target part feature related to a portion associated with the target part from a feature of the estimation target image, based on a learning result acquired by performing learning by using a reference image including an image of a target part and a target image including an image of the target part, and estimating a position of the target part, based on the target part feature.
21. The information processing method according to supplementary note 20, wherein
   estimating a position of the target part includes generating similarity degree information indicating a degree of similarity between a feature of the estimation target image and a reference feature being a feature of the reference image, and extracting the target part feature from a feature of the estimation target image, based on the similarity degree information.
22. The information processing method according to supplementary note 21, wherein
   extracting the target part feature includes
      generating the similarity degree information, based on a feature of the estimation target image and the reference feature, and
      extracting the target part feature from a feature of the estimation target image, based on the similarity degree information.
23. The information processing method according to supplementary note 22, wherein
   the learning result includes a learned feature extraction model subjected to machine learning for extracting a feature of the estimation target image, and
   extracting the target part feature further includes acquiring a feature of the estimation target image by using the feature xtraction model with the estimation target image as an input.
24. The information processing method according to any one of supplementary notes 21 to 23, wherein
   the learning result includes a learned position estimation model subjected to machine learning for estimating an in-region position indicating a position of the target part in an associated region being associated with the target part feature, and
   estimating a position of the target part includes estimating the in-region position by using the position estimation model with the target part feature as an input, and estimating a position of the target part, based on the in-region position.
25. The information processing method according to supplementary note 24, wherein
   estimating a position of the target part, based on the in-region position, includes
      determining a region position indicating a position of the associated region,
      estimating the in-region position by using the position estimation model with the target part feature as an input, and
      estimating a position of the target part, based on the region position and the in-region position.
26. The information processing method according to supplementary note 25, wherein
   estimating a position of the target part, based on the in-region position, further includes
      converting the estimated position of the target part into a position in the estimation target image.
27. The information processing method according to any one of supplementary notes 24 to 26, further including:
   obtaining a position loss being a loss related to the in-region position estimated by using the position estimation model with the target part feature of a feature of the target image as an input, based on a position loss function; and
   correcting the position estimation model, based on the position loss.
28. The information processing method according to supplementary note 27, wherein
   the position loss function is a function that does not include, in the position loss, a loss related to a position estimated by using the position estimation model with, as an input, the target part feature input to the position estimation model in a case where the target part feature is different from a portion associated with the target part.
29. The information processing method according to supplementary note 27 or 28, wherein
   the learning result includes a learned feature extraction model subjected to machine learning for extracting a feature of the estimation target image,
   the information processing method further includes obtaining a similarity degree loss being a loss related to the similarity degree information, based on the similarity degree information and a similarity degree loss function, and
   correcting the position estimation model includes further correcting the feature extraction model, based on the similarity degree loss.
30. The information processing method according to supplementary note 29, wherein
   correcting the position estimation model includes
      obtaining an integrated loss acquired by integrating the position loss and the similarity degree loss,
      correcting the feature extraction model, based on the integrated loss, and
      correcting the position estimation model, based on the integrated loss.
31. The information processing method according to any one of supplementary notes 24 to 30, further including
   displaying, on a display unit, a position of the target part in the estimation target and the associated region over the estimation target image in an overlapping manner.
32. The information processing method according to supplementary note 31, wherein
   displaying on the display unit includes displaying, on the display unit, a position of the target part in the estimation target in a more emphasized manner than the associated region.
33. The information processing method according to any one of supplementary notes 21 to 32, wherein
   the estimation target is a person,
   the target part is a pupil center,
   the reference image is a one eye image including only a predetermined eye,
   the target image is a both eyes image including both eyes, and
   the degree of similarity is a spatial cosine degree of similarity.
34. The information processing method according to supplementary note 33, wherein
   the target part is plural, and
   the information processing method further includes estimating a line-of-sight direction of a person being the estimation target, based on a position of each of the plurality of target parts.
35. The information processing method according to supplementary note 34, wherein
   the plurality of target parts further include an outer corner of an eye and an inner corner of an eye.
36. The information processing method according to supplementary note 34 or 35, further including
   outputting an alert related to the estimation target, based on the line-of-sight direction.
37. The information processing method according to any one of supplementary notes 20 to 36, wherein
   the target part includes at least one of a pupil center, an outer corner of an eye, and an inner corner of an eye.
38. A program for causing one or more computers to execute:
   acquiring an estimation target image including an image of a target part in an estimation target; and
   extracting a target part feature related to a portion associated with the target part from a feature of the estimation target image, based on a learning result acquired by performing learning by using a reference image including an image of a target part and a target image including an image of the target part, and estimating a position of the target part, based on the target part feature.
39. The program according to supplementary note 38, wherein
   estimating a position of the target part includes generating similarity degree information indicating a degree of similarity between a feature of the estimation target image and a reference feature being a feature of the reference image, and extracting the target part feature from a feature of the estimation target image, based on the similarity degree information.
40. The program according to supplementary note 39, wherein
   extracting the target part feature includes
      generating the similarity degree information, based on a feature of the estimation target image and the reference feature, and
      extracting the target part feature from a feature of the estimation target image, based on the similarity degree information.
41. The program according to supplementary note 40, wherein
   the learning result includes a learned feature extraction model subjected to machine learning for extracting a feature of the estimation target image, and
   extracting the target part feature further includes acquiring a feature of the estimation target image by using the feature extraction model with the estimation target image as an input.
42. The program according to any one of supplementary notes 39 to 41, wherein
   the learning result includes a learned position estimation model subjected to machine learning for estimating an in-region position indicating a position of the target part in an associated region being associated with the target part feature, and
   estimating a position of the target part includes estimating the in-region position by using the position estimation model with the target part feature as an input, and estimating a position of the target part, based on the in-region position.
43. The program according to supplementary note 42, wherein
   estimating a position of the target part, based on the in-region position, includes
      determining a region position indicating a position of the associated region,
      estimating the in-region position by using the position estimation model with the target part feature as an input, and
      estimating a position of the target part, based on the region position and the in-region position.
44. The program according to supplementary note 43, wherein
   estimating a position of the target part, based on the in-region position, further includes converting the estimated position of the target part into a position in the estimation target image.
45. The program according to any one of supplementary notes 42 to 44, further including:
   obtaining a position loss being a loss related to the in-region position estimated by using the position estimation model with the target part feature of a feature of the target image as an input, based on a position loss function; and
   correcting the position estimation model, based on the position loss.
46. The program according to supplementary note 45, wherein
   the position loss function is a function that does not include, in the position loss, a loss related to a position estimated by using the position estimation model with, as an input, the target part feature input to the position estimation model in a case where the target part feature is different from a portion associated with the target part.
47. The program according to supplementary note 45 or 46, wherein
   the learning result includes a learned feature extraction model subjected to machine learning for extracting a feature of the estimation target image,
   the program further includes obtaining a similarity degree loss being a loss related to the similarity degree information, based on the similarity degree information and a similarity degree loss function, and
   correcting the position estimation model includes further correcting the feature extraction model, based on the similarity degree loss.
48. The program according to supplementary note 47, wherein
   correcting the position estimation model includes
      obtaining an integrated loss acquired by integrating the position loss and the similarity degree loss,
      correcting the feature extraction model, based on the integrated loss, and
      correcting the position estimation model, based on the integrated loss.
49. The program according to any one of supplementary notes 42 to 48, further including
   displaying, on a display unit, a position of the target part in the estimation target and the associated region over the estimation target image in an overlapping manner.
50. The program according to supplementary note 49, wherein
   displaying on the display unit includes displaying, on the display unit, a position of the target part in the estimation target in a more emphasized manner than the associated region.
51. The program according to any one of supplementary notes 39 to 50, wherein
   the estimation target is a person,
   the target part is a pupil center,
   the reference image is a one eye image including only a predetermined eye,
   the target image is a both eyes image including both eyes, and
   the degree of similarity is a spatial cosine degree of similarity.
52. The program according to supplementary note 51, wherein
   the target part is plural, and
   the program further includes estimating a line-of-sight direction of a person being the estimation target, based on a position of each of the plurality of target parts.
53. The program according to supplementary note 52, wherein
   the plurality of target parts further include an outer corner of an eye and an inner corner of an eye.
54. The program according to supplementary note 52 or 53, further including
   outputting an alert related to the estimation target, based on the line-of-sight direction.
55. The program according to any one of supplementary notes 38 to 54, wherein
   the target part includes at least one of a pupil center, an outer corner of an eye, and an inner corner of an eye.
56. A storage medium storing a program for causing one or more computers to execute:
   acquiring an estimation target image including an image of a target part in an estimation target; and
   extracting a target part feature related to a portion associated with the target part from a feature of the estimation target image, based on a learning result acquired by performing learning by using a reference image including an image of a target part and a target image including an image of the target part, and estimating a position of the target part, based on the target part feature.
57. A storage medium storing the program according to any one of supplementary notes 39 to 55.

This application is based upon and claims the benefit of priority from Japanese patent application No. 2022-103353, filed on Jun. 28, 2022, the disclosure of which is incorporated herein in its entirety by reference.

### REFERENCE SIGNS LIST

100, 300, 400, 500, 800 Information processing apparatus
101 Target image acquisition unit
102 Reference image acquisition unit
103 Storage unit
110, 110a to 110c Position estimation unit
120 Extraction unit
121 Feature acquisition unit
122 Reference feature acquisition unit
123 Generation unit
124 Feature extraction unit
130 Estimation unit
131 Region determination unit
132 First estimation unit
133 Second estimation unit
134 Conversion unit
401 Line-of-sight acquisition unit
402 Alert unit
501 Similarity degree loss acquisition unit
502 Position loss acquisition unit
510 Correction unit
511 Loss integration unit
512 Feature extraction model correction unit
513 Position estimation model correction unit
801 Display unit
802 Display control unit
900 Information processing system
901 Capturing apparatus

What is claimed is:

1. An information processing apparatus comprising:
at least one memory configured to store instructions; and
at least one processor configured to execute the instructions to:
acquire an estimation target image including an image of a target part in an estimation target; and
extract a target part feature related to a portion associated with the target part from a feature of the estimation target image, based on a training result acquired by performing training by using a reference image including an image of a target part and a target image including an image of the target part, and estimates a position of the target part, based on the target part feature.

2. The information processing apparatus according to claim 1, wherein
the at least one processor configured further to execute the instructions to:
generate similarity degree information indicating a degree of similarity between the feature of the estimation target image and a reference feature being a feature of the reference image, and
extract the target part feature from the feature of the estimation target image, based on the similarity degree information.

3. The information processing apparatus according to claim 2, wherein
the similarity degree information is generated, based on the feature of the estimation target image and the reference feature.

4. The information processing apparatus according to claim 3, wherein
the training result includes a learned feature extraction model subjected to machine training for extracting the feature of the estimation target image, and
the feature of the estimation target image is acquired by using the feature extraction model with the estimation target image as an input.

5. The information processing apparatus according to claim 2, wherein
the training result includes a learned position estimation model subjected to machine training for estimating an in-region position indicating a position of the target part in an associated region being associated with the target part feature,
the in-region position is estimated by using the position estimation model with the target part feature as an input, and
a position of the target part is estimated, based on the in-region position.

6. The information processing apparatus according to claim 5, wherein
estimation the position of the target part includes
determining a region position indicating a position of the associated region,
estimating the in-region position by using the position estimation model with the target part feature as an input, and
estimating the position of the target part, based on the region position and the in-region position.

7. The information processing apparatus according to claim 6, wherein
estimation the position of the target part further includes converting the estimated position of the target part into a position in the estimation target image.

8. The information processing apparatus according to claim 5, wherein
the at least one processor configured further to execute the instructions to:
obtain a position loss being a loss related to the in-region position estimated by using the position estimation model with the target part feature of a feature of the target image as an input, based on a position loss function; and
correct the position estimation model, based on the position loss.

9. The information processing apparatus according to claim 8, wherein
the position loss function is a function that does not include, in the position loss, a loss related to a position estimated by using the position estimation model with, as an input, the target part feature input to the position estimation model in a case where the target part feature is different from a portion associated with the target part.

10. The information processing apparatus according to claim 8, wherein
the at least one processor configured further to execute the instructions to:
obtain a similarity degree loss being a loss related to the similarity degree information, based on the similarity degree information and a similarity degree loss function, and
the training result includes a learned feature extraction model subjected to machine training for extracting the feature of the estimation target image,
and
the feature extraction model is corrected, based on the similarity degree loss.

11. The information processing apparatus according to claim 10, wherein
correcting the feature extraction model includes
obtaining an integrated loss acquired by integrating the position loss and the similarity degree loss,
correcting the feature extraction model, based on the integrated loss, and
correcting the position estimation model, based on the integrated loss.

12. The information processing apparatus according to claim 5, wherein
the at least one processor configured further to execute the instructions to:
display, on a display, a position of the target part in the estimation target and the associated region over the estimation target image in an overlapping manner.

13. The information processing apparatus according to claim 12, wherein
the position of the target part in the estimation target is displayed in a more emphasized manner than the associated region.

14. The information processing apparatus according to claim 2, wherein
the estimation target is a person,
the target part is a pupil center,
the reference image is a one eye image including only a predetermined eye,
the target image is a both eyes image including both eyes, and
the degree of similarity is a spatial cosine degree of similarity.

15. The information processing apparatus according to claim 14, wherein
the target part is plural, and
the at least one processor configured further to execute the instructions to:
estimate a line-of-sight direction of a person being the estimation target, based on a position of each of the plurality of target parts.

16. The information processing apparatus according to claim 15, wherein
the plurality of target parts further include an outer corner of an eye and an inner corner of an eye.

17. The information processing apparatus according to claim 15, wherein
the at least one processor configured further to execute the instructions to:
output an alert related to the estimation target, based on the line-of-sight direction.

18. The information processing apparatus according to claim 1, wherein
the target part includes at least one of a pupil center, an outer corner of an eye, and an inner corner of an eye.

19. (canceled)

20. An information processing method comprising,
by one or more computers:
acquiring an estimation target image including an image of a target part in an estimation target; and
extracting a target part feature related to a portion associated with the target part from a feature of the estimation target image, based on a training result acquired by performing training by using a reference image including an image of a target part and a target image including an image of the target part, and estimating a position of the target part, based on the target part feature.

21. A non-transitory computer readable medium storing a program for causing one or more computers to execute:
acquiring an estimation target image including an image of a target part in an estimation target; and
extracting a target part feature related to a portion associated with the target part from a feature of the estimation target image, based on a training result acquired by performing training by using a reference image including an image of a target part and a target image including an image of the target part, and estimating a position of the target part, based on the target part feature.
